(19) United States
(12) Patent Application Publication
(10) Pub. No.: US 2025/0108336 A1
(43) Pub. Date: Apr. 3, 2025

(54) POLYMER SURFACE FOR CONDUCTIVE MEMBRANES AND METHODS OF MAKING THEREOF

(71) Applicant: THE UNIVERSITY OF NORTH CAROLINA AT CHAPEL HILL, Chapel Hill, NC (US)

(72) Inventors: Orlando CORONELL NIETO, Chapel Hill, NC (US); Wei ZHANG, Chapel Hill, NC (US)

(21) Appl. No.: 18/865,142

(22) PCT Filed: May 15, 2023
(86) PCT No.: PCT/US2023/022273

§ 371 Date: Nov. 12, 2024

Related U.S. Application Data
(60) Provisional application No. 63/341,694, filed on May 13, 2022.

(51) Int. Cl. B01D 69/10; B01D 65/08; B01D 67/00; B01D 71/02; B01D 71/60

(52) U.S. Cl. CPC B01D 69/107; B01D 65/08; B01D 67/00046; B01D 71/021; B01D 71/601; B01D 2321/281; B01D 2323/21819; B01D 2323/26; B01D 2323/30; B01D 2325/02834; B01D 2325/26

(57) ABSTRACT

Electrically conductive membranes (ECMs) have been demonstrated in the literature as a promising tool to enhance the performance of membrane-based water/wastewater treatment technologies. Membrane surface functionalization with “active” conductive materials is a direct and effective approach to obtain membranes with electrically conductive properties. However, a general strategy that could be utilized to fabricate ECMs using any types of commercial membrane (e.g., reverse osmosis, nanofiltration, ultrafiltration, and microfiltration) as a support or any type of conductive material as ‘active material’ is not available yet. To address this need, the subject matter described herein is a facile and low-cost polyethyleneimine/glutaraldehayde-based method for synthesis of electrically conductive membranes starting from a broad range of commercial membranes (i.e., SWC4+, ESPA3, NF 270, PSf 20 KDa, and 0.1 μm PVDF membranes) by using graphite or other conductive materials, including but not limited to, carbon nanotubes, activated charcoal, reduced graphene oxide, and silver nanoparticles.

### CROSS-REFERENCE TO RELATED APPLICATIONS

This application claims the benefit of and priority to U.S. Provisional Patent Application No. 63/341,694, filed on May 13, 2022, the entire contents of which are incorporated by reference herein.

### STATEMENT REGARDING FEDERALLY SPONSORED RESEARCH OR DEVELOPMENT

This invention was made with government support under P42 ES031007 awarded by the National Institute of Health (NIH). The government has certain rights in the invention.

### BACKGROUND

Water is essential for life on earth as well as global economic development. However, water scarcity has been accelerating exponentially in the past decade due to rapid industrialization, population growth, and climate change [1, 2]. To address the water crisis, membrane-based seawater and brackish water treatment, and wastewater reclamation have been widely utilized for producing potable and agricultural irrigation water [3-5]. All membranes still face the great challenge posed by fouling and biofouling which often lead to significant decline in water flux, solute rejection, and even membrane lifespan due to needed frequent physical/chemical cleaning. Thus, membranes that are self-cleaning or antifouling are appealing. Electrically conductive membranes (ECMs) are particularly appealing due to their high self-cleaning efficiency over long-term operation [13-16].

What is generally lacking in this field are facile and low-cost methods of rendering existing membranes conductive via surface-modification of various membranes with “active” conductive materials. Therefore, a modification method that can be used for different types of membranes and “active” conductive materials including inexpensive options, such as graphite, is required. The subject matter described herein addresses the shortcomings in this field.

### BRIEF SUMMARY

In certain embodiments, the subject matter described herein is directed to an electrically conductive filtration membrane comprising:
a porous or nonporous matrix; and
an electrically conductive layer disposed on the porous matrix, the electrically conductive layer comprising surface-modified electrically conductive material disposed on the porous matrix and an amine-containing polymer crosslinked to the surface-modified electrically conductive material.

In certain embodiments, the subject matter described herein is directed to a method of preparing the electrically conductive membrane, comprising:
contacting a porous or nonporous matrix with a first solution of an electrically conductive crosslinking solution comprising a surface-modified electrically conductive material bound to a crosslinking agent,
   wherein the surface-modified electrically conductive material is deposited on the surface of the porous or nonporous matrix via filtration or non-filtration to form a first membrane; and
contacting the first membrane with a second solution of an amine-containing polymer,
   wherein the polymer is crosslinked to the surface-modified electrically conductive material to form the electrically conductive layer disposed on the porous or nonporous matrix.

In certain embodiments, the subject matter described herein is directed to a method of modifying the pore size of a porous matrix layer, comprising:

contacting the porous matrix and surface-modified electrically conductive material disposed on the surface of the porous matrix with an amine-containing polymer, wherein the polymer is crosslinked to the surface-modified electrically conductive material on the surface of the porous matrix, and optionally directly within the pores of the porous matrix;

wherein the pore size of the porous matrix decreases in size.

In certain embodiments, the subject matter described herein is directed to a method of preventing or reducing fouling of a non-conductive pristine membrane, comprising:
contacting a non-conductive pristine membrane with a first solution of electrically conductive crosslinking solution comprising a surface-modified electrically conductive material bound to a crosslinking agent,
   wherein the surface-modified electrically conductive material is deposited on the surface of the non-conductive pristine membrane via filtration or non-filtration to form a first membrane; and contacting the first membrane with a second solution of an amine-containing polymer,
   wherein the polymer is crosslinked to the surface-modified electrically conductive material to form an electrically conductive layer disposed on the non-conductive pristine membrane;
      wherein an electrically conductive filtration membrane is prepared.

In certain embodiments, the subject matter described herein is directed to a method of purifying a liquid feed stream, comprising:
allowing the liquid feed stream to filter through an electrically conductive filtration membrane comprising:
   a porous or nonporous matrix; and
   an electrically conductive layer disposed on one side of the porous matrix, the electrically conductive layer comprising surface-modified electrically conductive material disposed on the porous or nonporous matrix and an amine-containing polymer crosslinked to the surface-modified electrically conductive material;
      wherein a purified liquid is produced.

Additional aspects are also described herein.

### BRIEF DESCRIPTION OF THE DRAWING(S)

FIGS. 1a-1h. Schematic diagrams of the filtration setup used to prepare the graphite-coated PVDF conductive membrane (FIG. 1a) and the range of conditions tested for optimization (FIG. 1b). The synthesized membranes were immersed in water and stirred overnight at 130 rpm. Top-view (FIGS. 1c-1d), cross-section (FIGS. 1e-1f), cross-section EDS mapping (FIG. 1g) by scanning electron microscopy (SEM) imaging of pristine and graphite-coated PVDF membrane under optimized conditions, and schematic of the proposed PEI-based cross-linking method for conductive membrane preparation (FIG. 1h). Optimized membrane modification condition: 8 mL of 20 mg/mL graphite with 2.5 wt % glutaraldehyde was coated on a 90-mm diameter coupon of a 0.1 μm unmodified PVDF membrane via vacuum filtration, and then 0.4 mL of 10 wt % PEI in ethanol was poured on membrane.

FIGS. 2a-2d. Survey scan (FIG. 2a) and high-resolution N 1s scan (FIG. 2b) XPS spectra of the pristine PVDF and graphite-coated PVDF membranes. Raman spectra (FIG. 2c) of graphite powder, PVDF membrane, and graphite-coated PVDF membrane. ATR-FTIR spectra (FIG. 2d) of graphite powder, PVDF membrane, PEI-PVDF membrane, and graphite-coated PVDF membrane.

FIGS. 3a-3e. Water permeance (FIG. 3a) and single-salt (1 g/L) rejection (FIG. 3b) of graphite-coated PVDF membranes. Zeta potential (FIG. 3c) of pristine PVDF and PVDF-m1 membranes in 1 mM KC1 under different solution pH conditions. Schematic illustration (FIG. 3d) of a lab-scale electrochemical oxidation system used for MB degradation (30 mg/L in 100 mM NaCl) using a graphite-coated PVDF membrane (i.e., PVDF-m1) as the cathode and a platinum (Pt) electrode as the anode. MB degradation with time (FIG. 3e) with and without applied voltage. The PVDF-m1 membrane means the modification was done on 0.1 μm PVDF membrane under the optimized preparation condition. Error bars represent standard deviation (n≥3).

FIGS. 4a-4c. Possible graphite stabilization mechanisms (FIG. 4a) when using the PEI-based crosslinking on porous and nonporous membranes. Images of PSf 20 KDa membranes modified with different “active” conductive materials (i.e., CNTs, rGO, activated charcoal, Ag nanoparticles) using the PEI/glutaraldehyde-based crosslinking method (FIG. 4b) and their sheet resistance (FIG. 4c). Membrane modification conditions: 4 mL of 20 mg/mL active material with 2.5 wt % glutaraldehyde was coated on a 48 mm diameter coupon of a PSf 20 KDa membrane at 200 psi, and then 0.2 mL of 10 wt % PEI in ethanol was poured on membrane.

FIGS. 5a-5c. Representative images of the synthesized graphite-coated PVDF membranes under three different combinations between PEI and glutaraldehyde after overnight stirring at 120 rpm and then sonicated from 1 h to 5 h at 50° C. in water. The arrows indicate the defect areas on the membrane surface.

FIGS. 6a-6b. Evidence of the controllable thickness of graphite-coated PVDF membrane when using less (FIG. 6a) or more (FIG. 6b) amount of graphite. Modification conditions: 4 mL (or 12 mL) of 20 mg/mL graphite with 2.5 wt % glutaraldehyde was coated on a PVDF membrane (90-mm diameter) via vacuum filtration, and then 0.2 mL (or 0.6 mL) of 10 wt % PEI in ethanol was poured on membrane.

FIGS. 7a-7b. The C 1s XPS spectra (a) and MWCO (b) of the graphite coated PVDF membrane (PVDF-m1). Error bars represent standard deviation (n≥2).

FIG. 8. The structure of graphite-coated PVDF electrically conductive membrane.

FIG. 9a-9b. The utilized Pt anode (FIG. 9a) and membrane cathode (FIG. 9b) in the MB degradation experiment. The membrane was glued by a double-sided tape on the microscopy slide. the glued area of the membrane electrode was outside of the solution during the experiment. Only the membrane (not the wire or tape) was in the MB solution during the MB degradation experiment.

FIGS. 10a-10h. The images of graphite functionalized commercial membranes (e.g., PSf 20 KDa, NF270, ESPA3, and SWC4+ membrane; FIGS. 10a-10d, respectively) by using the PEI-based crosslinking method, and their permeability before and after modification (10e-10h). Modification conditions: all membranes (48 mm diameter) were coated with 2 mL of 20 mg/mL graphite containing 2.5 wt % glutaraldehyde, and then 0.1 mL of PEI solution (10 wt % in ethanol) was poured on the coated membrane surface.

FIGS. 11a-11e. SEM images of CNTs (FIG. 11a), rGO (FIG. 11b), activated charcoal (FIG. 11c), and Ag NPs (FIG. 11d), and XRD patterns (FIG. 11e) of the PSf 20 KDa membrane modified with various active conductive materials.

FIG. 12. Schematic illustration of the lab-scale dead-end filtration setup used for membrane antifouling experiments (i.e., static adsorption and dynamic filtration).

FIGS. 13a-13b. (a) Schematic diagram of the spray coating combined with PEI-based surface crosslinking strategy used for large-scale fabrication of ECM without the assistance of vacuum/pressure-driven force at room temperature. (b) One representative image of fabricated ECM with an active size of ˜12 cm (width)×18 cm (length) by using this procedure and its stability after 1 h sonication or overnight air-dry. Here, the condition used for the synthesis of ECM was as follows: 100 mg/mL of graphite ethanol solution containing 2.5 wt % of glutaraldehyde was sprayed on the PSf base membrane surface, and then 3.5 wt % of PEI ethanol solution was gently poured on the graphite functionalized PSf membrane surface.

FIGS. 14a-14d. Top-view and cross-section SEM images of pristine PSf base membrane (a-b) and fabricated ECM (c-d).

FIGS. 15a-15b. Water permeance of pristine PSf base membrane and fabricated ECMs using 2.5 wt % of glutaraldehyde but with different concentrations of PEI (a). The BSA rejection of pristine PSf membrane and synthesized UF ECMs when using 2 wt % and 3.5 wt % of PEI (left part in b), and the single-salt rejection of synthesized NF ECMs when 5 wt % of PEI was used (right part in b). Error bars represent standard deviation (n≥5).

FIGS. 16a-16d. (a) Zeta potential of pristine PSf membrane, fabricated UF and NF ECMs, and PEI-coated PSf membrane. (b) The contact angle of pristine PSf membrane and synthesized UF/NF ECM. (c) The FRRs of PSf UF membrane and fabricated UF/NF ECM in 24 h static adsorption of 0.2 g/L of BSA or 0.1 g/L of sodium alginate in 10 mM NaCl and 0.5 mM CaCl₂ solution. (d) Representative flux changes of PSf UF membrane, NF90, and fabricated UF/NF ECMs during the filtration of 0.2 g/L of BSA in 10 mM NaCl and 0.5 mM CaCl₂ solution. The tests were conducted under a similar initial flux for the UF membrane (i.e., ˜72 L/m²/h) and NF membrane (i.e., ˜33 L/m²/h) by adjusting the applied transmembrane pressure. Herein, 100 mg/mL of graphite ethanol solution containing 2.5 wt % of glutaraldehyde was sprayed on the PSf membrane surface, then gently added 3.5 wt % or 5 wt % of PEI to the graphite-coated PSf membrane surface to synthesize the UF ECM 3.5% or NF ECM 5%, respectively. Error bars represent standard deviation (n≥2).

FIG. 17. Range of conditions between glutaraldehyde and PEI used to optimize synthesis of physically stable ECMs.

FIGS. 18a-18d. Top-view and cross-section SEM images of fabricated ECMs using 2 wt % (a-b) and 10 wt % (c-d) of PEI to stabilize the graphite-glutaraldehyde layer. Here, those two types of membranes were fabricated by spray coating the graphite solution (100 mg/mL in ethanol) containing 2.5 wt % of glutaraldehyde on PSf membrane surface and then stabilized by PEI solution (i.e., 2 wt % and 10 wt %).

FIG. 19. Flux recovery ratio (FRR) of PSf membrane, NF90, and fabricated UF/NF ECMs during the filtration of 0.2 g/L of BSA in 10 mM NaCl and 0.5 mM CaCl₂ solution in each cycle. Error bars represent standard deviation (n≥2).

FIGS. 20a-20b. Zeta potential (a) and water contact angle (b) of NF90 commercial membrane and fabricated NF ECM when 5 wt % of PEI was utilized. Error bars represent standard deviation (n≥3).

FIGS. 21a-21e. Representative images of fabricated graphite-related ECMs based on different commercial membranes (e.g., SWC4+ seawater RO (a), ESPA3 brackish water RO (b), NF90 (c), and NF270 (d)) and their water permeance changes (d) after surface functionalization with graphite particles followed by spray coating combined with PEI/glutaraldehyde-based cross-linking procedure. Herein, 100 mg/mL of graphite ethanol solution containing 2.5 wt % of glutaraldehyde was sprayed on each membrane surface. Then, 2 wt % of PEI was gently added to the graphite-coated membrane surface. Error bars represent standard deviation (n≥5).

### DETAILED DESCRIPTION

Described herein is a surface functionalization strategy that can be applied broadly to various commercial membranes, including but not limited to, SWC4+ and ESPA3 RO, NF270, PSf 20 KDa, and 0.1 μm PVDF UF membranes, to bestow electrical conductivity and improve performance of the membranes. This strategy can be applied across a broad range of substrate membranes resulting in functionalized membranes that have erstwhile not been available. Also, the methods described herein can require significantly less resources than known methods of functionalizing membranes. Described herein are methods for synthesis of electrically conductive membranes using a polymer cross-linking method to functionalize various membranes with conductive materials. In embodiments described herein, the electrically conductive material is surface-modified and cross-linked with an amine-containing polymer to form an electrically conductive layer which is disposed onto a porous matrix, such as but not limited to, commercial membranes for reverse osmosis, nanofiltration, ultrafiltration, and microfiltration. Described herein is improved separation performance of functionalized electrically conductive membranes than their insulating pristine counterparts.

In certain embodiments, the subject matter described herein is directed to the use of polyethyleneimine (PEI) as the polymer to facilitate crosslinking of the glutaraldehyde-treated electrically conductive material. In certain embodiments, the electrically conductive layer is formed from various “active” conductive materials, including but not limited to, graphite, carbon nanotubes, reduced graphene oxides, activated charcoal, and silver nanoparticles.

In certain embodiments, the membranes are useful in water/wastewater treatment technologies. In certain embodiments, described herein are methods of removing contaminants from water and/or an aqueous composition containing at least one contaminant comprising using a surface functionalized membrane that is electrically conductive due to the presence of conductive material such as, but not limited to, graphite, carbon nanotubes, reduced graphene oxides, activated charcoal, and/or silver nanoparticles. In certain embodiments, the methods described herein comprise contacting contaminated water or aqueous composition containing at least one contaminant, such as but not limited to a liquid feed stream, with a surface-functionalized membrane that contains an electrically conductive layer cross-linked to the membrane via a polymer-based cross-linking method.

As mentioned above, membrane-based water treatment and wastewater reclamation are important processes for producing potable and agricultural irrigation water. However, fouling and biofouling of membranes often leads to a decline in membrane performance through reduced water flux, solute rejection, and lifespan. The methods described herein allow membranes to be made electrically conductive via surface-functionalization with electrically conductive materials, thereby, extending the lifespan of the membrane and improving the membrane's self-cleaning capabilities. Membranes can be made antifouling by approaches such as blending [6, 7], coating [8, 9], or grafting [10-12] with different types of antifouling materials.

By applying an electric potential to the conductive membrane, the conductive membrane exerts a strong electrostatic repulsion force to foulants [17]. At higher voltages, the membrane can also generate reactive species that inactivate attached microorganisms [18], reduce/oxide toxic heavy metals (e.g., arsenite (III) and chromium (VI) [19]) or even degrade foulants on the membrane surface or in the water system [20].

To obtain membranes with electrically conductive properties, the choice of “active” material is often limiting. Since most conductive metal particles/nanoparticles (e.g., silver, copper, and gold) are expensive and tend to dissolve in solution, carbon-based materials including graphene [21], carbon nanotubes (CNTs) [22], and reduced graphene oxide (rGO) [23] have been widely implemented in recent years. In particular, CNTs have been predominantly used for membrane modification procedures to render membranes electrically conductive [23, 24]. Polyvinyl alcohol (PVA)-based crosslinking is the most commonly utilized method for functionalization of ultrafiltration membrane surfaces by using CNTs or graphene-based conductive “active” material [16, 25-27], whereas for forward osmosis membranes the only reported approach is the physical blending of “active” material and polymer during the polyamide layer formation [28, 29]. The PVA-based approach requires a relatively long fabrication time as well as acid and heat crosslinking conditions. In contrast, the methods described herein are applicable across any known electrically conductive materials.

Owing to the low chlorine resistance of polyamide [30], CNTs functionalized forward osmosis membranes might be not stable in the treatment of waters containing chloride ions (e.g., seawater and brackish water) due to production of chlorine gas when the electricity was applied. In addition, both approaches were specifically used with hydrophilic CNTs functionalized with carboxylic groups, and it is unclear whether or not the reported procedures could be extended to other conductive materials. Therefore, a modification method that can be used for different types of membranes (e.g., RO, NF, and UF) and conductive active materials including more inexpensive options than CNTs such as graphite is required.

Membrane-based water treatment processes are plagued with reduced membrane permeability due to fouling and/or biofouling of the membranes which reduces their efficiency and requires frequent physical or chemical cleaning. Antifouling membranes have been developed using various techniques, including, but not limited to, blending [6, 7], coating [8, 9], or grafting [10-12] with different types of antifouling materials. An appealing antifouling technique is the use of electrically conductive membranes to electrolyze contaminated water. Electrolysis, as described herein, is a technique that electrochemically oxidizes or reduces contaminants in water by applying electric energy to wastewater containing inorganic or organic contaminants. Described herein are methods for generating electrically conductive separation membranes with enhanced membrane performance due to reduced membrane fouling, improved solute rejection, and degradation of charged contaminants.

In some embodiments, the subject matter described herein is a facile and cost-effective polyethyleneimine (PEI)/glutaraldehyde-based surface crosslinking method for the synthesis of electrically conductive membranes with a broad range of performance using different types of “active” conductive materials. In certain embodiments, the PEI/glutaraldehyde-based crosslinking method was optimized using membrane stability and electrical conductivity criteria. After that, changes in membrane separation performance (i.e., water permeability and solute rejection) upon membrane modification were quantified. Next, the electrochemical degradation of methylene blue (MB) by graphite-coated membrane was investigated as an illustrative application of the electrically conductive membranes. In embodiments described herein, coating of different commercial membrane surfaces (e.g., SWC4+ and EPSA3 RO, NF270, PSf 20 KDa UF, and 0.1 μm PVDF UF membranes) with inexpensive graphite yields conductive performance without affecting the underlying membrane structure. In embodiments described herein, the suitability of the PEI/glutaraldehyde-based crosslinking method for preparation of electrically conductive membranes with “active” conductive materials different from graphite (i.e., CNTs, rGO, activated charcoal, and silver nanoparticles) was demonstrated.

In some embodiments, the subject matter described herein is directed to PEI/glutaraldehyde-based surface crosslinking methodologies suitable for large-scale production of different types of electrically conductive membranes (ECMs), including, but not limited to, reverse osmosis (RO), nanofiltration (NF), and ultrafiltration (UF) ECMs. In some embodiments, the ECMs are produced from stable graphite-based ECMs. In certain embodiments, the large-scale production is facilitated without the support of vacuum/pressure-driven force. The properties of these graphite-based ECMs, including sheet resistance, static protein/sodium alginate adsorption behavior, dynamic filtration antifouling activity, and selective performance (i.e. salt or protein rejection) were studied. In embodiments described herein, the suitability of the PEI/glutaraldehyde-based surface crosslinking method for large-scale fabrication of graphite-based reverse osmosis, nanofiltration, and ultrafiltration ECMs with high stability, low sheet resistance, antifouling, and improved selective performance without the assistance of a vacuum/pressure-driven force was demonstrated.

The presently disclosed subject matter will now be described more fully hereinafter. However, many modifications and other embodiments of the presently disclosed subject matter set forth herein will come to mind to one skilled in the art to which the presently disclosed subject matter pertains having the benefit of the teachings presented herein. Therefore, it is to be understood that the presently disclosed subject matter is not to be limited to the specific embodiments disclosed and that modifications and other embodiments are intended to be included within the scope of the appended claims. In other words, the subject matter described herein covers all alternatives, modifications, and equivalents. In the event that one or more of the incorporated literature, patents, and similar materials differs from or contradicts this application, including but not limited to defined terms, term usage, described techniques, or the like, this application controls. Unless otherwise defined, all technical and scientific terms used herein have the same meaning as commonly understood by one of ordinary skill in this field. All publications, patent applications, patents, and other references mentioned herein are incorporated by reference in their entirety.

### I. Definitions

As used herein, “fouling” or “biofouling” refers to the accumulation of contaminants on the surface or pores of the membranes. The fouling materials can consist of living organisms such as, but not limited to, algae and bacterial settlements, referred to as biofouling, or non-living inorganic or organic substances, such as, but not limited to, natural organic matter; crystallization of solid salts, oxides, and/or hydroxides; accumulation of colloidal particulates; and/or corrosive deposits, or combinations of one or more foulants.

As used herein, “antifouling membranes” refer to membranes that prevent or reduce fouling. Antifouling membranes are often surface-functionalized membranes with a layer that prevents or reduces fouling. The use of electrically conductive materials for this purpose are described herein.

As used herein, “active” conductive materials refer to electrically conductive materials that can be attached to the separation membrane in order to bestow electrical conductivity to the membrane. In some embodiments, the “active” conductive material can be any conductive material known in the art. In some embodiments, the “active” conductive materials are selected from a group consisting of graphite, carbon nanotubes, activated charcoal, reduced graphene oxide, silver nanoparticles, and combinations thereof.

As used herein, “surface-modified,” “surface-modification,” and the like, refer to the polymer being covalently or non-covalently bound to the electrically conductive material via a crosslinking agent. In certain embodiments described herein, the surface-modified electrically conductive material can form an electrically conductive crosslinking solution which can be disposed on the surface of the porous matrix.

As used herein, “cross-linking” refers to the formation of bonds, covalent or non-covalent, that link a polymer chain to the electrically conductive material. Described herein are methods of generating electrically conductive membranes by cross-linking amine-containing polymers with a layer of “active” conductive materials, including but not limited to, graphite, activated charcoal, carbon nanotubes, reduced graphene oxide, silver nanoparticles, and/or combinations thereof.

As used herein, a “crosslinking agent,” “crosslinker,” and the like, refer to an aldehyde, a dialdehyde, a diacrylate, an epoxide, etc. that is capable of crosslinking, covalently or noncovalently, the polymer to the electrically conductive material.

As used herein, the term “residue” or “residue of” a chemical moiety or compound refers to a chemical moiety or compound that is bound to a molecule, whereby through the binding, at least one covalent bond has replaced at least one atom of the original chemical moiety or compound, resulting in a residue of the chemical moiety or compound in the molecule.

As used herein, “an amine-containing polymer,” refers to a polymer containing one or more primary, secondary, and/or tertiary amines that can be functionalized and/or crosslinked.

Designation of a range of values includes all integers within or defining the range, and all subranges defined by integers within the range.

Unless otherwise apparent from the context, the term “about” encompasses values within a standard margin of error of measurement of a stated value or variations ±0.5%, 1%, 5%, or 10% from a specified value.

Compositions or methods “comprising” or “including” one or more recited elements may include other elements not specifically recited. For example, a composition that “comprises” or “includes” a protein may contain the protein alone or in combination with other ingredients.

The singular forms of the articles “a,” “an,” and “the” include plural references unless the context clearly dictates otherwise. For example, the term “an antigen” or “at least one antigen” can include a plurality of antigens, including mixtures thereof.

Statistically significant means p≤0.05.

### II. Membranes

Described herein are electrically conductive membranes comprising a porous or nonporous matrix and an electrically conductive layer disposed on the surface of the porous or nonporous matrix, wherein the electrically conductive layer comprises an amine-containing polymer cross-linked to surface-modified electrically conductive material via a crosslinking agent. Porous and non-porous matrices as defined in this field are known in the art.

In embodiments described herein, the electrically conductive layer is comprised of electrically conductive material that can be any electrically conductive material known in the art. In certain embodiments, the electricaly conductive material selected from the group consisting of graphite, activated charcoal, carbon nanotubes, reduced graphene oxide, and silver nanoparticles. In certain embodiments, the electrically conductive material is surface-modified with a crosslinking agent. In certain embodiments, the electrically conductive material is graphite. In certain embodiments, the electrically conductive material is graphite having a certain particle size.

In certain embodiments, the crosslinking agent is selected from among the group consisting of aldehydes, dialdehydes, diacrylates, and epoxides. In certain embodiments, the crosslinking agent is a dialdehyde. In certain embodiments, the crosslinking agent is glutaraldehyde.

In embodiments described herein, the amine-containing polymer crosslinked to the electrically conductive material contains one or more primary, secondary, and/or tertiary amines. In certain embodiments, the amine-containing polymer is a branched amine-containing polymer. In certain embodiments, the branched amine-containing polymer contains primary, secondary, and tertiary amines. In certain embodiments, the amine-containing polymer is polyethyleneimine (PEI). In certain embodiments, the polyethyleneimine is branched (M_{w}˜25 kDa). In embodiments described herein, the polymer crosslinked to the electrically conductive material is not polyvinyl alcohol (PVA).

In embodiments, the crosslinked amine-containing polymer is present in an amount from about 2 wt % to about 20 wt % of the amine-containing polymer solution. In certain embodiments, the crosslinked amine-containing polymer is present in an amount from about 5% to about 15% by weight of the amine-containing polymer solution. In certain embodiments, the amine-containing polymer is present in about 8% to about 12% by weight of the amine-containing polymer solution. In certain embodiments, the amine-containing polymer is present in about 10% by weight of the amine-containing polymer solution. In one embodiment, the amine-containing polymer is polyethylenimine and is present in about 10% by weight of the amine-containing polymer solution.

In embodiments described herein, the crosslinking agent is present in amount from about 1 wt % to about 10 wt % of the crosslinking solution, wherein the crosslinking solution comprises the crosslinking agent and the conductive material. In certain embodiments, the crosslinking agent is present in about 1% to about 5% by weight of the crosslinking solution. In certain embodiments, the crosslinking agent is present in about 2.5% by weight of the crosslinking solution. In one embodiment, the crosslinking agent is glutaraldehyde and is present in about 2.5% by weight of the crosslinking solution.

In embodiments described herein, the electrically conductive layer has a thickness of about 0.1 μm to about 50 μm. In certain embodiments, the electrically conductive layer has a thickness of about 1 μm to about 45 μm. In certain embodiments, the electrically conductive layer has a thickness of about 10 μm to 40 μm. In certain embodiments, the electrically conductive layer has a thickness of about 20 μm to about 30 μm. In certain embodiments, the electrically conductive layer has a thickness of about 100 nm, 200 nm, 300 nm, 400 nm, 500 nm, 600 nm, 700 nm, 800 nm, 900 nm, or about 1000 nm. In certain embodiments, the electrically conductive layer has a thickness of about 1 μm, 2 μm, 3 μm, 4 μm, 5 μm, 6 μm, 7 μm, 8 μm, 9 μm, or about 10 μm. In certain embodiments, the electrically conductive layer has a thickness of about 10 μm, 11 μm, 12 μm, 13 μm, 14 μm, 15 μm, 16 μm, 17 μm, 18 μm, 19 μm, 20 μm, 21 μm, 22 μm, 23 μm, 24 μm, 25 μm, 26 μm, 27 μm, 28 μm, 29 μm, 30 μm, 31 μm, 32 μm, 33 μm, 34 μm, 35 μm, 36 μm, 37 μm, 38 μm, 39 μm, 40 μm, 41 μm, 42 μm, 43 μm, 44 μm, 45 μm, 46 μm, 47 μm, 48 μm, 49 μm, or 50 μm. In certain embodiments, the electrically conductive layer has a thickness of about 20 μm. In certain embodiments, the electrically conductive layer has a thickness of about 25 μm. In certain embodiments, the electrically conductive layer has a thickness of about 30 μm. In some embodiments, the thickness of the electrically conductive layer affects the water permeance and performance of the ECM. In certain embodiments, thinner electrically conductive layers allow for improved water permeance and overall membrane performance.

In some embodiments, the porous or nonporous matrix is a non-conductive pristine membrane selected from a group consisting of a reverse osmosis membrane, an ultrafiltration membrane, a nanofiltration membrane, and a microfiltration membrane. In some embodiments, the porous matrix is any one of NF270, PSf 20 KDa and PVDF membranes. In certain embodiments, the porous matrix is a PVDF membrane. In some embodiments, the PVDF membrane has a pore size from about 0.1 μm to about 0.8 μm. In certain embodiments, the PVDF membrane has a pore size of 0.1 μm. In embodiments described herein, the electrically conductive membranes fabricated herein have increased antifouling compared to the porous matrices without the electrically conductive layer. In some embodiments, the porous matrix is a semipermeable matrix comprising a non-conductive pristine membrane. In some embodiments, the semipermeable matrix is a SWC4+ or an ESPA3 membrane.

In some embodiments, the pore size of the porous matrix is modified by the addition of the electrically conductive layer. In some embodiments, the amine-containing polymer is crosslinked not only on the surface of the porous matrix but also within the pores of the porous matrix. In some embodiments, the crosslinking within the pores of the porous matrix stabilizes the electrically conductive layer and thus the electrically conductive filtration membrane. In some embodiments, the membrane permeance is modified by the addition of the electrically conductive layer. In some embodiments, a membrane with a larger pore size is functionalized with an electrically conductive layer in order to maintain similar membrane permeance as the pristine membrane with a smaller pore size.

### III. Methods of Making

Described herein are methods of fabricating electrically conductive filtration membranes comprising a porous or nonporous matrix and an electrically conductive layer, wherein the porous or nonporous matrix is first contacted with an electrically conductive crosslinking solution; the surface-modified electrically conductive material is deposited on the surface of the porous matrix via any known technique, such as filtration, to form a first membrane. The first membrane is subsequently contacted with an amine-containing polymer to form the electrically conductive layer and stabilize the electrically conductive filtration membrane. In certain embodiments, the first membrane is unstable.

In certain embodiments, the electrically conductive crosslinking solution comprises electrically conductive material and a crosslinking agent. In certain embodiments, the electrically conductive material is graphite, carbon nanotubes, activated charcoal, reduced graphene oxide, or silver nanoparticles. In certain embodiments, the electrically conductive material is graphite. In certain embodiments, the crosslinking agent is an aldehyde, a dialdehyde, a diacrylate, or an epoxide. In certain embodiments, the crosslinking agent is a dialdehyde. In certain embodiments, the crosslinking agent is a residue of glutaraldehyde.

In certain embodiments, the crosslinking solution is filtered onto the porous matrix by vacuum filtration or pressure-driven filtration. Pressure-driven filtration could be dead-end filtration or crossflow filteration, or any other pressure-driven filtration known in the art. In some embodiments, alternative filtration techniques could be used including but not limited to osmotic filtration. In some embodiments, alternative methods of deposition known in the art could be used including but not limited to spray deposition or settlement.

In certain embodiments, the crosslinking solution is spread on to the nonporous or porous matrix to form a homogenous coating. Spray deposition can also be referred to as spray-coated fabrication and can be accomplished via any applicable spray apparatus known in the art. In certain embodiments, the spray apparatus is an electric paint sprayer. In certain embodiments, spray deposition of the crosslinking solution comprising the electrically conductive material facilitates the use of smaller particle sized electrically conductive material, such as, but not limited to, graphite particles.

In embodiments described herein, the electrically conductive material used has a particle size of about 0.01 μm to about 25 μm. In certain embodiments, the electrically conductive material has a particle size of about 1 μm to about 20 μm. In certain embodiments, the electrically conductive material has a particle size of about 5 μm to about 15 μm. In certain embodiments, the electrically conductive material has a particle size of 0.01 μm to about 1 μm. In certain embodiments, the electrically conductive material has a particle size of about 10 nm, 20 nm, 30 nm, 40 nm, 50 nm, 60 nm, 70 nm, 80 nm, 90 nm, 100 nm, 200 nm, 300 nm, 400 nm, 500 nm, 600 nm, 700 nm, 800 nm, 900 nm, or about 1000 nm. In certain embodiments, the electrically conductive material has a particle size of about 1 μm, 2 μm, 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm, 21 μm, 22 μm, 23 μm, 24 μm, or about 25 μm.

In embodiments described herein, the matrix bearing the surface-modified electrically conductive material is contacted with a solution of amine-containing polymer and allowed to air dry. In certain embodiments, the amine-containing polymer is polyethyleneimine.

In embodiments, the crosslinking agent is bound to the electrically conductive material and reacts with the polymer when the polymer is applied. In embodiments, the polymer can also additionally directly react with the membrane. Each of these reactions can contribute to stability of the final membrane.

The disclosed subject matter is further described in the following non-limiting Examples. It should be understood that these Examples, while indicating preferred embodiments of the invention, are given by way of illustration only.

### EXAMPLES

### Materials for Pressure-Driven Fabrication

Graphite powder (<20 μm), activated charcoal, sodium borohydride (NaHB₄), branched polyethyleneimine (PEI, M_{w}˜25 kDa), glutaraldehyde (25 wt % in water) were purchased from Sigma Aldrich. The PVDF durapore membrane with different pore sizes (i.e., 0.1, 0.45, and 0.8 μm) was ordered from Millipore-Sigma. The NF270 membrane was bought from Dupont Water Solutions, Minneapolis, USA. Polysulfone (PSf; ˜20 KDa) ultrafiltration commercial membranes were purchased from Nanostone Water Inc., California, USA. The seawater SWC4+and brackish water ESPA3 reverse osmosis membranes were bought from Hydranautics, California, USA. The carbon nanotubes (CNTs) with 20-30 nm outer diameter was obtained from Cheap Tubes Inc., USA. All chemicals were used without further purification. Laboratory grade water (LGW, resistivity >17.8 MΩ.cm) was used in all the experiments.

### Materials for Spray-Coated Fabrication

Graphite powder (<10 μm), polyethyleneimine (PEI, branched, M_{w}˜25 kDa), bovine serum albumin (BSA), magnesium sulfate anhydrous (MgSO₄), and glutaraldehyde (25 wt % in water) were bought from Sigma Aldrich, USA. Regent alcohol (ethanol), sodium alginate, sodium chloride (NaCl), sodium sulfate anhydrous (Na₂SO₄), and calcium chloride dihydrate (CaCl₂.2H₂O) were purchased from Fisher, USA. The NF90 and NF270 membranes were received from Dupont Water Solutions, Minneapolis, USA. Polysulfone (PSf) UF membrane was obtained from Nanostone Water Inc., California, USA. The seawater SWC4+ and brackish water ESPA3 RO membranes were ordered from Hydranautics, California, USA. A 400 W electric paint sprayer (ASIN: BOB5HHCBG2) with three nozzles and three painting modes was bought from Amazon, USA. All chemicals were used directly without any purification. Laboratory-grade water (LGW) was used in all experiments.

Synthesis of Reduced Graphene Oxide (rGO) and Silver (Ag) Nanoparticles

Reduced graphene oxide (rGO) was prepared by oxidation of graphite using a modified Hummer's method followed by a one-step reduction reaction using NaBH₄ that was previously described [32, 40]. Ag nanoparticles were synthesized by a one-step in-situ reduction reaction, similarly to as described by Saifur et al [41]. Briefly, 1.14 g of NaBH₄ was added into 20 mL of 1 M AgNO₃ solution at room temperature, and the obtained precipitate was dried at 105° C. for two days and subsequently ground to a small size.

### Characterization of the Modified Membranes (Pressure-Driven Fabrication)

The membrane surface and cross-section changes before and after modification were investigated by using scanning electron microscopy (SEM; Hitachi S-4700, Japan). Membrane surface chemistry properties were investigated by the attenuated total reflection Fourier-transform infrared spectroscopy (ATR-FTIR; Spectrum 400, PerkinElmer) and X-ray photoelectron spectroscopy (XPS; ESCALAB 250, Thermo Fisher Scientific, USA). The membrane electrical conductivity behavior was measured by a two-probe multimeter (FLUKE 87-5) at room temperature that was previously described [19]. Membrane surface charge was measured by the streaming potential instrument (SurPASS, Anton Paar, Austria) at pH 4-9 in 1 mM KCI solution using an adjustable gap holder at room temperature. In addition, Raman spectroscopy (Thermo Scientific DX3i Raman Spectrometer with an excitation at 532 nm) and X-ray diffraction (XRD; Bruker-AXS D8, Germany) analyses were performed.

### Characterization of the Modified Membranes (Spray-Coated Fabrication)

The membrane surface and cross-section were investigated using scanning electron microscopy (SEM; Hitachi S-4700, Japan). Membrane sheet resistance was measured by using a two-probe multimeter (FLUKE 87-5, USA) at room temperature. The surface water contact angle, which directly reflects membrane hydrophilicity, was checked by the captive bubble method and then calculated based on the descriptions in our previous works [49, 50]. In addition, the membrane surface charge was measured and compared using a streaming potential instrument (SurPASS, Anton Paar, Austria) at different pH in 1 mM KCl solution.

### MB Degradation by Graphite-Coated Membrane

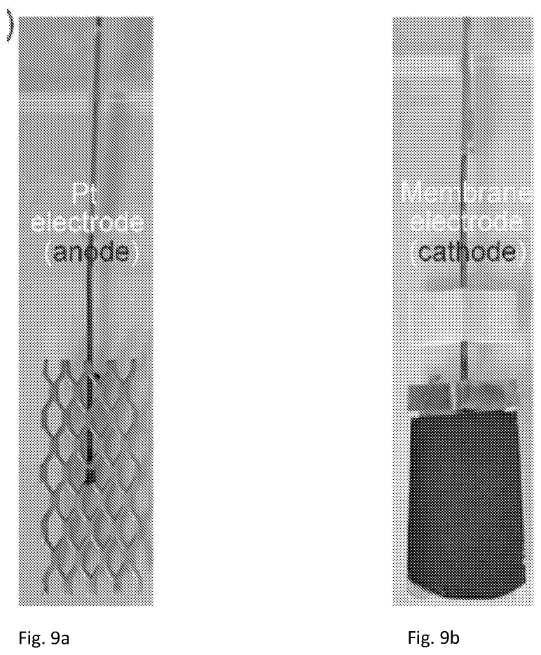

The degradation of methylene blue (MB) by graphite-coated PVDF membrane was evaluated by using a custom two-electrode electrochemical reaction setup to which a 5 V bias was applied by a power station (MPJA 9312-PS, China). One strip of graphite-coated PVDF membrane (˜2.5 cm (wide)×3.5 cm (long), see FIG. 9a) served as the cathode and a platinum wire served as the anode (FIG. 9b). The cathode and anode were immersed in 100 mL laboratory-grade water (LGW) containing 100 mM of NaCl and 30 mg/L MB under constant magnetic stirring. The MB concentration was measured as a function of time during 60 min by sampling the test solution and analyzing it using a UV-spectrophotometer (UV-1800, Shimadzu) at 664 nm.

### Membrane Permeability and Separation Performance for Pressure-Driven Fabrication

Membrane water permeance and salt rejection were measured by using water and aqueous single-salt solutions (1 g/L; MgSO₄, CaCl₂, Na₂SO₄, or NaCl) in a stirred (350 rpm) dead-end filtration cell (HP4750, Sterlitech) at 13.79 bar. The molecular weight cut-off (MWCO) of the graphite-coated PVDF membrane was evaluated by measuring the rejection of different sizes of polyethylene glycol (PEGs, 200, 400, 600, 1000, and 2000 Da), and it was defined as the molecular weight that is 90% rejected. The rejection experiments were carried out at room temperature. Briefly, following membrane compaction with LGW (˜30 min), the PEGs solution (0.2 g/L, 100 mL) was filtered at 13.79 bar, and 2 mL of the permeate was collected. PEG rejection was calculated by comparing the PEG concentrations in feed and permeate via a HPLC-SRM-MS/MS using an Accela 600 HPLC coupled with TSQ Quantum Ultra mass spectrometry (Thermo Fisher Scientific).

Water permeance (L_{P}, L/m²/h/bar) was calculated as

$${L}_{P} = \frac{V}{A \times Δ t \times P} ,$$

where V (L) is the volume of permeate solution, A (m²) is the effective membrane area (0.001385 m2), Δt (h) is the permeation time, and P (bar) is transmembrane pressure.

Salt rejection (R, %) was determined by comparing the conductivity of feed and permeate (i.e., filtered) water as given by

$$R ( \% ) = ( \frac{\hat{} f - \hat{} p}{\hat{} f} ) \times 100 , \qquad ( 2 )$$

where Λ_{f} (μS/m) and Λ_{P} (μS/m) are the feed conductivity and permeate conductivity, respectively.

### Membrane Permeability and Separation Performance for Spray-Coated Fabrication

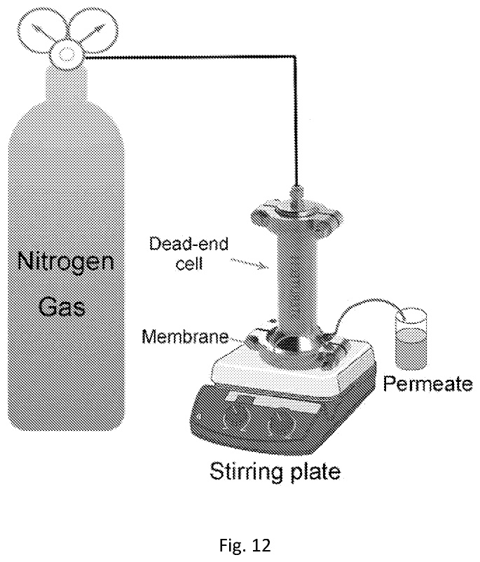

Membrane water permeance, antifouling behavior, and separation performances (i.e., NF ECM for single-salt solution, 1 g/L of MgSO₄, CaCl₂, Na₂SO₄, or NaCl; UF ECM for protein, 1 g/L of BSA) were investigated in a stirred (350 rpm) dead-end filtration cell (HP4750, Sterlitech), respectively. The filtration setup was schematized in FIG. 12. Following membrane compaction with LGW (˜4 h), the salt or protein solution was filtered at room temperature, and then 5 mL of permeate and feed (in the dead-end cell) were collected. The membrane permeability (L₀, LMH/bar) was calculated based on Equation (1). The salt rejection of synthesized NF ECM was measured by comparing the conductivity difference between feed and permeate. The BSA rejection of synthesized UF ECM was calculated by comparing the absorption changes before and after filtration using a UV-spectrophotometer (Hp 8452A, USA) at 280 nm. The membrane static adsorption activity was tested as follows: 200 mL of foulant solution (i.e., 200 mg/L of BSA or 100 mg/L of sodium alginate in 10 mM NaCl and 0.5 mM CaCl₂) was poured into the dead-end cell after membrane was compacted, stirred for 24 h at 350 rpm at room temperature and then removed. The dead-end cell with membrane was gently rinsed three times with LGW to remove unabsorbed BSA or sodium alginate, and then the permeability of fouled membrane (Lᵢ, LMH/bar) (i=1) to LGW was measured. Membrane antifouling performance was reflected by the flux recovery ratio (FRR, %) before and after foulant adsorption [12]. The FRR was calculated based on the following equation:

$$F R {R}_{i} ( \% ) = \frac{{L}_{i}}{{L}_{0}} \times 100 \qquad ( 3 )$$

The membrane antifouling activity for 200 mg/L of BSA in 10 mM NaCl and 0.5 mM CaCl2 solution was also evidenced under dynamic filtration conditions at a similar initial flux in the dead-end filtration setup. Three filtration cycles (1 h for each) were performed, and the membrane flux was monitored for each 5 min. The fouled membrane from each cycle was washed with background solution (i.e., 10 mM NaCl and 0.5 mM CaCl₂ solution) three times without filtration, and then its flux for LGW was measured. To better compare membrane antifouling efficiency, the FRR of tested membranes (i.e., UF PSf, UF ECM 3.5%, NF90, and NF ECM 5% membranes) in each filtration cycle (i=1, 2, 3) was further calculated by the equation mentioned above.

### Example 1: Fabrication of Graphite-based Conductive Membrane

### Synthesis of Conductive Membranes by Using PEI/Glutaraldehyde-Based Crosslinking Via Vacuum/Pressure-Driven Fabrication

Before modification, membranes were washed with 50% ethanol for 24 h at room temperature to remove the impurities on the membrane surface or inside membrane pores. For membrane modification using graphite as the active conductive material, a graphite solution (20 mg/mL in water) containing 2.5 wt % glutaraldehyde was prepared and stirred at 130 rpm overnight. Next, 2-4 mL of the graphite-glutaraldehyde solution was filtered on the membrane surface (active area of 12.56 cm2) by either vacuum filtration (i.e., 0.1-0.8 μm PVDF membranes) or dead-end filtration at 200 psi (i.e., PSf 20 KDa, NF270, ESPA3, and SWC4+ membranes). Then, 0.2-0.4 mL of PEI solution (0-15 wt % in ethanol) was gently added to the membrane surface, air dried for a few minutes, and then the membrane was immersed in water and stirred at 130 rpm for 12 h to remove the unstable graphite particles and non-crosslinked PEI. The resulting membrane was stored in LGW at room temperature until use. Membranes were also modified using CNT, rGO, activated charcoal, and Ag NPs using the same PEI/glutaraldehyde-based procedure.

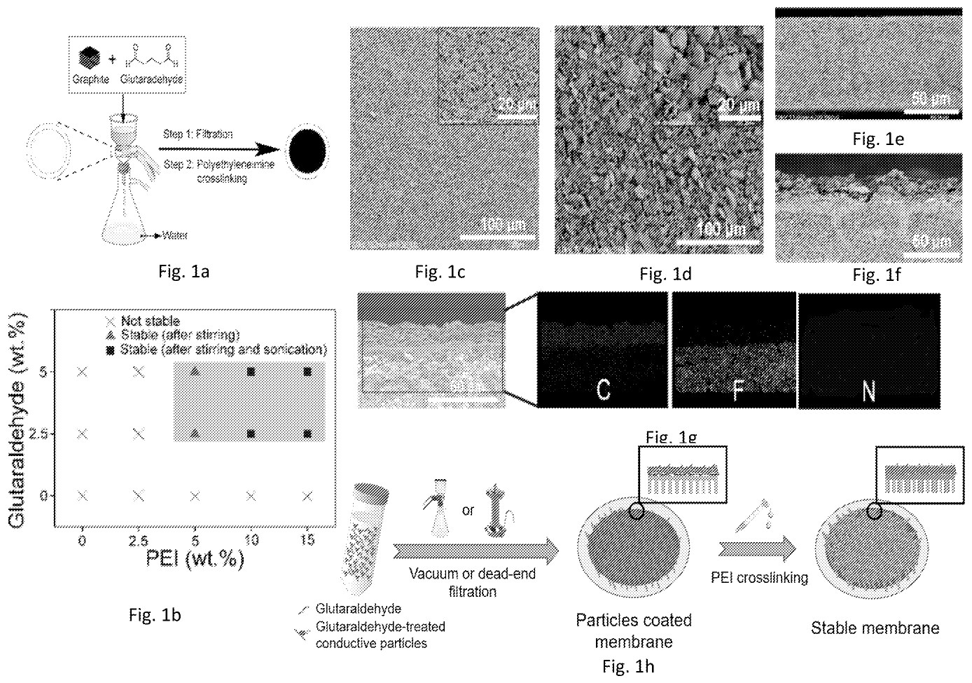

FIG. la illustrates graphite as the representative “active” material used for the preparation of conductive membranes via the proposed PEI/glutaraldehyde-based crosslinking method. Briefly, the glutaraldehyde molecules surrounded graphite particles and evenly coated the membrane surface with the assistance of a filtration driving force. The graphite-PEI layer was then stabilized by the crosslinking between PEI and glutaraldehyde on the membrane surface and/or inside the membrane pores (FIG. 1h). The preparation condition was first optimized based on the membrane stability after an overnight stirring in water followed by a few hours of bath sonication at 50° C. Graphite-coated PVDF membranes were not stable when using only PEI or only glutaraldehyde or a lower concentration of PEI (<5 wt %, FIG. 1b). Although graphite-coated membranes were obtained when using a PEI concentration of 5 wt %, those membranes were not stable under external sonication and heat conditions (FIGS. 1b and 5a-5b). Considering that a high concentration of PEI might result in low water permeance, the combination of 2.5 wt % of glutaraldehyde and 10 wt % of PEI was selected as the optimized condition and used for preparation of graphite-coated membranes (FIG. 5c).

### Characterization of Conductive Membranes by Using PEI/Glutaraldehyde-Based Crosslinking

The changes in membrane surface and cross-section microstructure upon functionalization with graphite were investigated by SEM analysis. As seen from FIGS. 1c-d, the unmodified PVDF membrane (FIG. 1c) showed a relatively smooth surface with a homogenous distribution of surface pores, whereas the surface of the graphite-coated PVDF membrane (FIG. 1d) was fully covered by graphite particles. The cross-section SEM images in

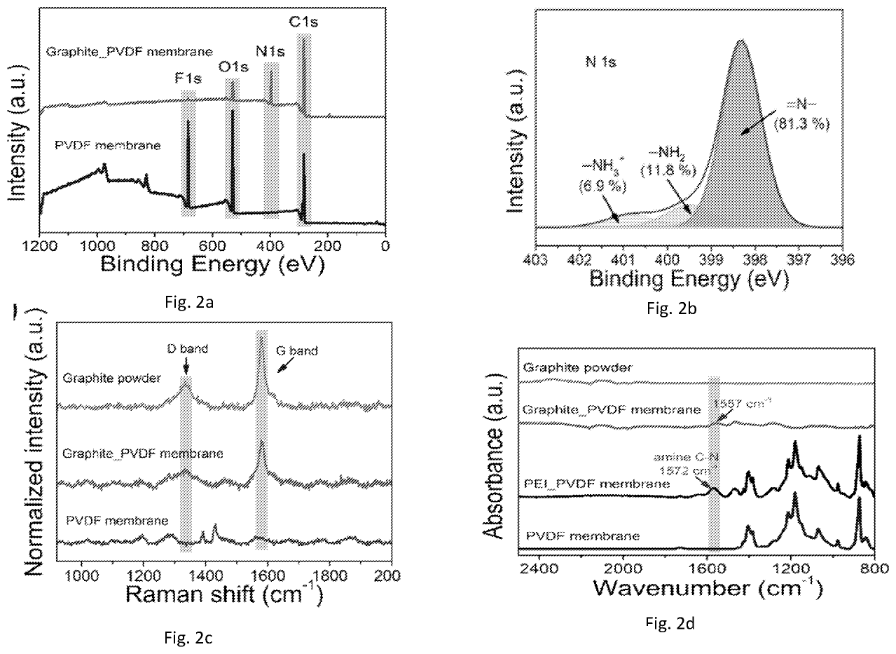

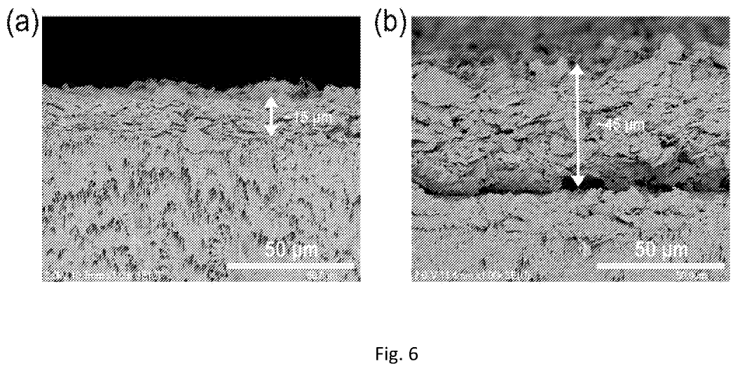

FIGS. le-f evidence that a graphite layer (˜30 μm) was present on the PVDF membrane surface. The thickness of this conductive layer could be controlled by simply adjusting the graphite amount deposited on the membrane surface (see FIGS. 6a-6b). The cross-section energy-dispersive X-ray spectroscopy (EDS) element mapping analysis in FIG. 1g shows that a carbon (C) layer was present on the top of the PVDF membrane (represented by the fluorine (F) signal), confirming the successful coating of graphite on the PVDF membrane surface. While a nitrogen (N) signal from PEI was absent in the graphite layer of the graphite-coated PVDF membrane due to its weak EDS signal [31, 32], nitrogen presence was confirmed in the graphite layer by XPS analysis via detection of a nitrogen peak and amino (—NH₂ or —NH₃⁺) and imide groups (═N—) in the survey and N 1 s scans of the graphite-coated PVDF membrane surface (FIGS. 2a-b).

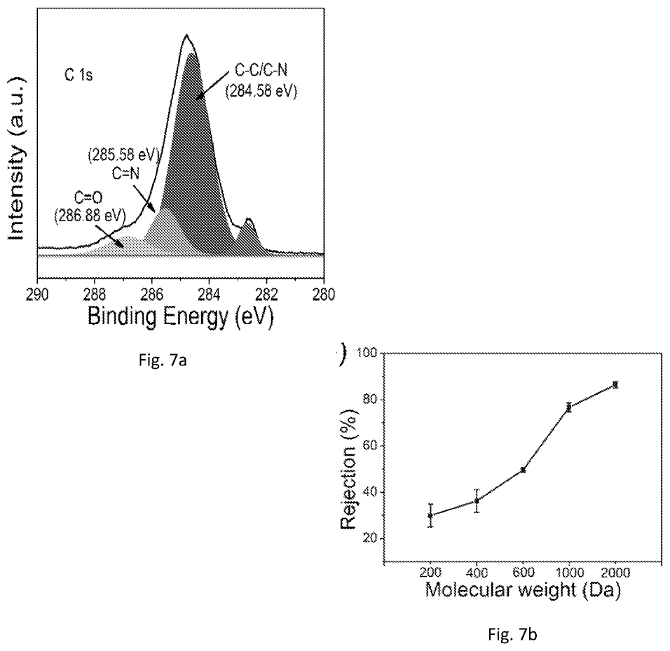

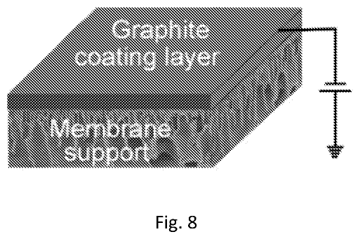

Raman spectra of the PVDF membrane, graphite powder, and graphite-coated PVDF membrane are displayed in FIG. 2c. As seen, the graphite exhibits two intense peaks at 1335 cm⁻¹ and 1577 cm⁻¹, which are assigned to the D band and G band of graphite [33], respectively. These two peaks are present in the graphite-coated PVDF membrane while the specific peaks (˜1400 cm⁻¹) belonging to the PVDF membrane disappeared, illustrating the graphite covered the PVDF membrane. The existence of PEI and crosslinking between PEI and glutaraldehyde were confirmed by ATR-FTIR analysis (FIG. 2d). For the PEI-coated PVDF membrane, the ATR-FTIR spectra show a new absorption peak at 1572 cm⁻¹ associated with the C—N bond which was attributed to the terminal amine of PEI [34]. This peak is also present in the graphite-coated PVDF membrane spectra but with much lower intensity, and the adsorption band shifted to a lower wavenumber (1557 cm⁻¹), indicating the cross-linking between PEI and glutaraldehyde occurred. The cross-linking reaction between the amino group of PEI and carbonyl groups of glutaraldehyde [35, 36] on the graphite-coated PVDF membrane is further evidenced by the ═N— and C═N signal in the N 1s (FIG. 2b) and C 1s (FIG. 7a) XPS scans. Owing to the existence of graphite on membrane surface, the functionalized PVDF membrane is thus electrically conductive (FIG. 8). The synthesized graphite-coated PVDF membrane shows a relatively low sheet resistance (3.2±1.5 kΩ/sq), which is better than most of reported conductive membranes/thin films in the literature (see Table 1).

TABLE 1
Electrical resistance of different conductive membranes or thin films.

| | Resistance | |
|---|---|---|
| Membrane/films | (kQ/Sq) | Reference |
| PA-CNT coated PES membrane | 6.4 ± 0.4 | [29] |
| Polypyrrole modified PVDF membrane | 11.4 ± 0.04 | [42] |
| EDOT modified PVDF membrane | 14.07 | [43] |
| Laser-reduced GO coated PES membrane | ~1 | [47] |
| Porous LIG membrane | <0.1 | [48] |
| rGO-MWNTs thin film | 8 | [44] |
| PEI-GO thin film | <5 | [45] |
| GO sheets | 0.8-19 | [46] |
| Graphite-coated PVDF membrane | 3.2 ± 1.5 | This work |
| CNTs-coated PSf membrane | 1.5 ± 0.6 | This work |
| rGO-coated PSf membrane | 15.6 ± 2.5 | This work |
| Activated charcoal-coated PSf membrane | 9.2 ± 1.3 | This work |
| Ag NPs-coated PSf membrane | <0.02 | This work |

### Example 2: Water Permeance and Salt Rejection by Electrically Conductive Membrane

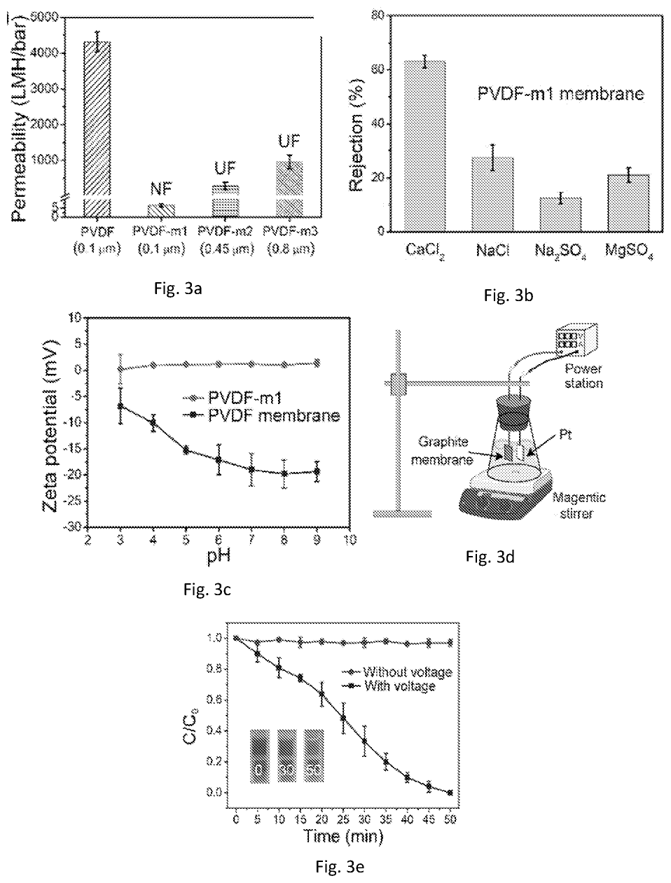

FIG. 3a shows the water permeance before and after surface modification with graphite. The water permeance of the PVDF membrane (0.1 μm) significantly decreased from ˜4300 L/m²/h/bar to 7 L/m²/h/bar after the graphite coating (i.e., PVDF-ml membrane) due to increased resistance to water transport by pore blocking and the newly formed PEI-graphite layer. Although the synthesized PVDF-ml membrane had low water permeance, the permeance of the modified membrane can be tailored by using different base membranes. For example, to obtain a looser conductive membrane in the nanofiltration to ultrafiltration range, one can simply replace the base PVDF membrane with a bigger pore size membrane (e.g., 0.45 and 0.8 μm; see FIG. 3a). As shown in FIG. 3b, the graphite-coated PVDF membrane (0.1 μm) rejected different single-salt solutions in decreasing order of CaCl₂>NaCl>Mg₂SO₄>Na₂SO₄; this order is consistent with the rejection order by positively charged NF membranes [37, 38]. The nanofiltration behavior of the graphite-coated PVDF membrane (0.1 μm) was also supported by its low MWCO (˜2 kDa, see in FIG. 7b). This membrane had a slight positive surface charge as determined by zeta potential analysis (FIG. 3c).

### Example 3: Methylene Blue Degradation by Electrically Conductive Membrane

As described previously, the graphite layer renders the fabricated graphite-coated PVDF membrane electrically conductive (i.e., average sheet resistance <3.5 kΩ/sq). To demonstrate the possible application potentials of graphite-coated PVDF conductive membrane, the dye degradation performance was evaluated in a stirred batch electrochemical degradation setup (FIG. 3d) with 30 mg/L MB in 100 mM NaCl solution using the prepared membrane as the cathode and a platinum electrode as the anode. The results in FIG. 3e show the MB concentration significantly decreased with time, under an applied voltage of 5 V. MB was completely degraded within 50 min, demonstrating that the graphite-coated PVDF membrane possesses an electro-degradation performance with the assistance of electricity. The mechanism by which MB is degraded is the electrochemical oxidation of MB to CO₂ and H₂O by reactive radicals (e.g., hydroxyl, oxygen, and hydrochloride) generated at the anode (Pt) and cathode (membrane) [20, 39].

### Example 4: General Applicability of PEI/Glutaraldehyde-Based Surface Crosslinking Method to Different Base Membranes and “Active” Materials

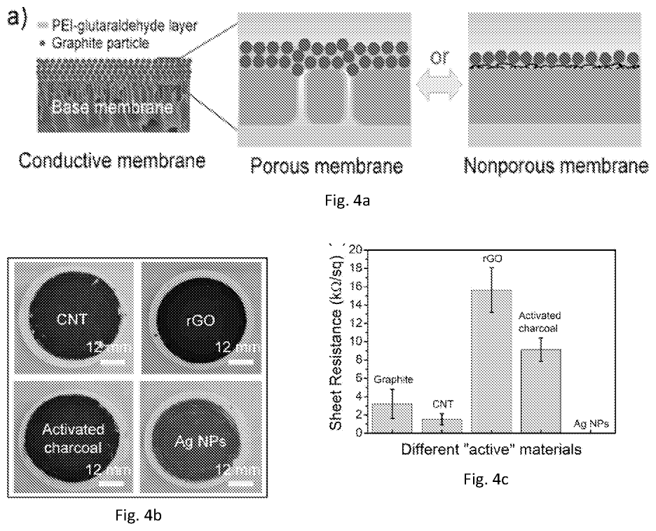

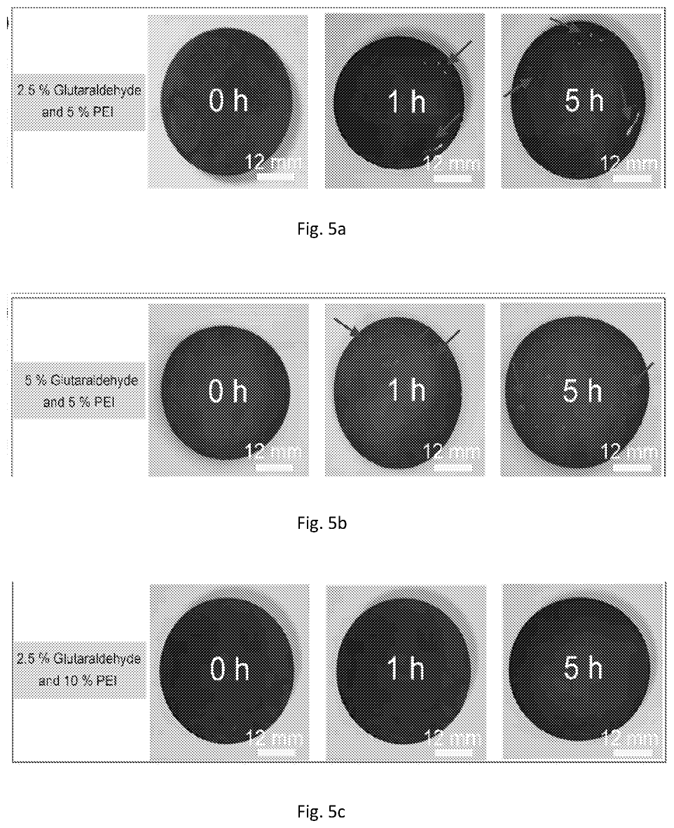

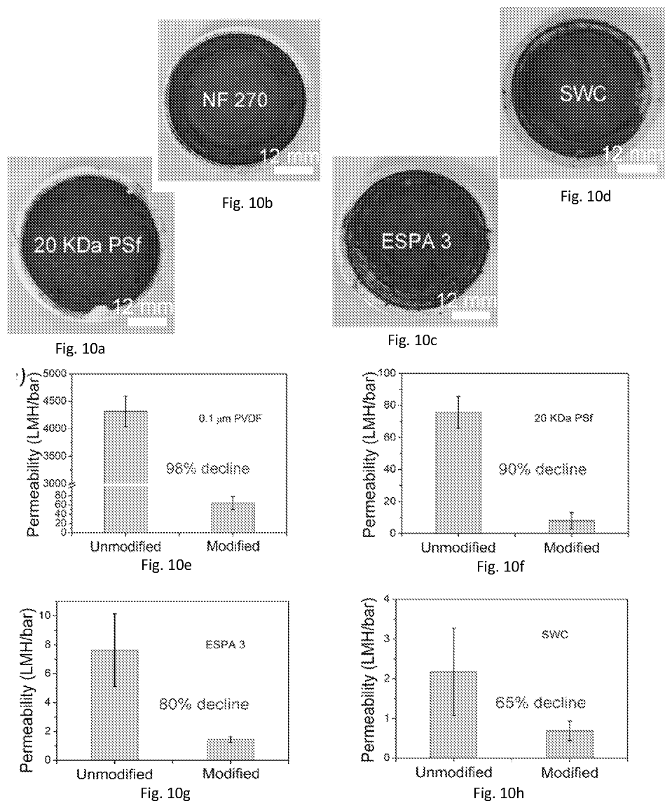

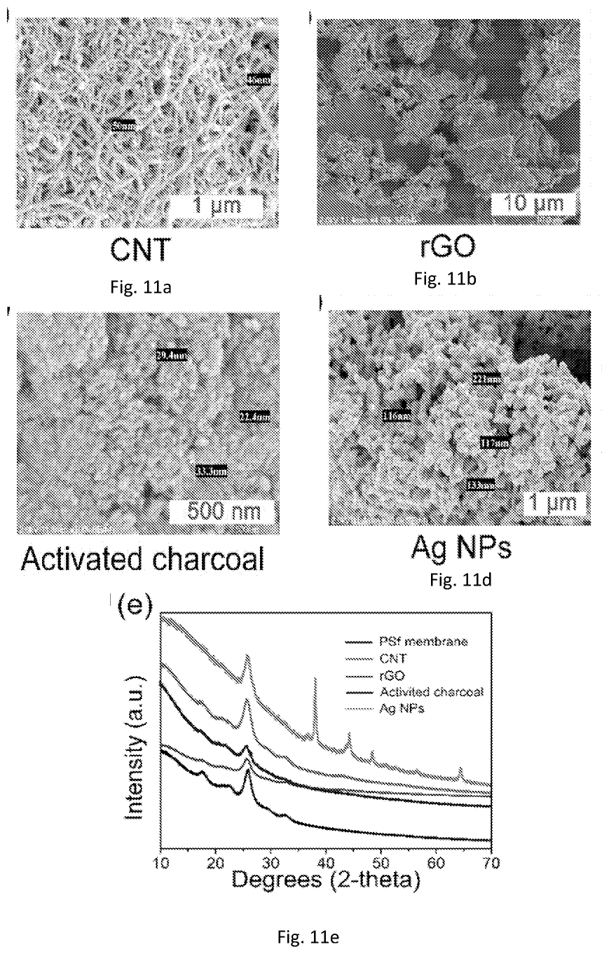

To identify the practical application potential of the proposed PEI/glutaraldehyde-based crosslinking method, including the general applicability of the described fabrication procedures to produce ECMs on any support membrane with any conductive material, the fabrication procedure was used with four commercial membranes (e.g., PSf 20 KDa, NF270, ESPA3, and SWC4+) using graphite as the active material and four additional “active” conductive materials (i.e., CNT, rGO, activated charcoal, and Ag NPs). The images of graphite functionalized membranes in FIGS. 10a-10d demonstrate that the PEI/glutaraldehyde-based crosslinking method is suitable for application to different types of membranes. The thickness of graphite layer on porous membranes (e.g., PSf 20 KDa and NF 270) is controllable, however, there is a limited thickness for nonporous membranes (e.g., ESPA3 and SWC4+) above which the graphite layer is not stable. A plausible explanation for the instability of thicker graphite layers on nonporous base membranes is as follows. When porous base membranes are used, the graphite layer is stabilized by crosslinking reactions happening both on the membrane surface and inside the membrane pores; however, in non-porous membranes only surface crosslinking occurs, as illustrated in FIG. 4a. This interpretation is supported by the significant flux decline for the porous membranes (98% of 0.1 μm PVDF and 90% of PSf 20 KDa) compared with that for the nonporous membranes (80% of ESPA3 and 65% of SWC4+) under the same membrane modification conditions (see FIGS. 10e-h). Although the thickest graphite layer on the nonporous membrane was relatively thin (10-15 μm) compared with that of porous membranes (30-50 μm), the functionalized ESPA3 and SWC4+ membranes are still electrically conductive (sheet resistance <5 kΩ/sq). In addition to graphite, other conductive “active” materials including CNT, rGO, activated charcoal, and Ag NPs (FIGS. 11a-11d) were also utilized for membrane surface functionalization using the PEI/glutaraldehyde-based crosslinking method. The images of synthesized membranes in FIG. 4b and their X-ray diffraction (XRD) patterns in FIG. 1le confirm that the proposed PEI/glutaraldehyde-based crosslinking method is successful regardless of the conductive material used. The membrane sheet resistance values in FIG. 4c and Table 1 indicate that different levels of electrical conductivity are obtained when different “active” materials are used with the PEI-based crosslinking method.

### Example 5: Controllable Spray Deposition (Spray-Coated) Fabrication of Stable Graphite-Based Ultrafiltration (UF) and Nanofiltration (NF) ECMs by Using PSf UF Membrane as Base Membrane

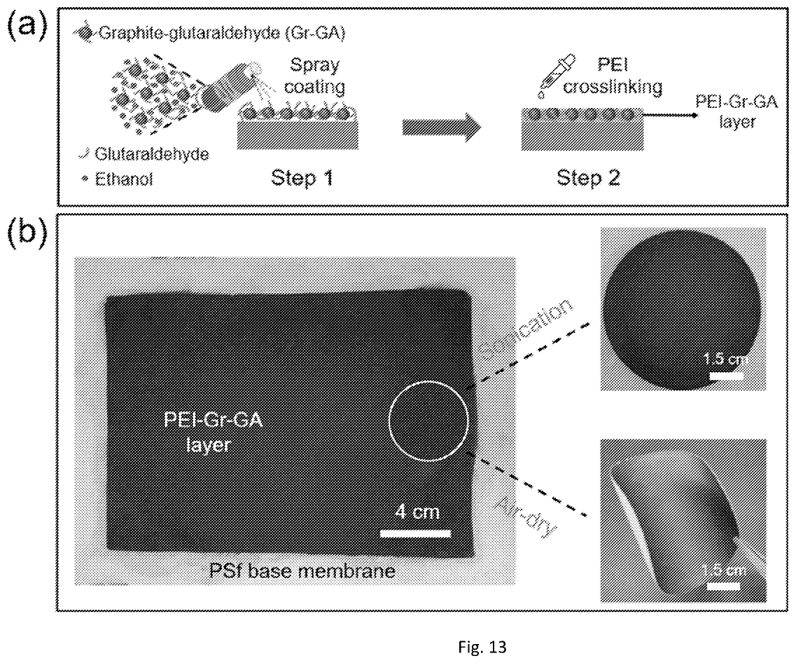

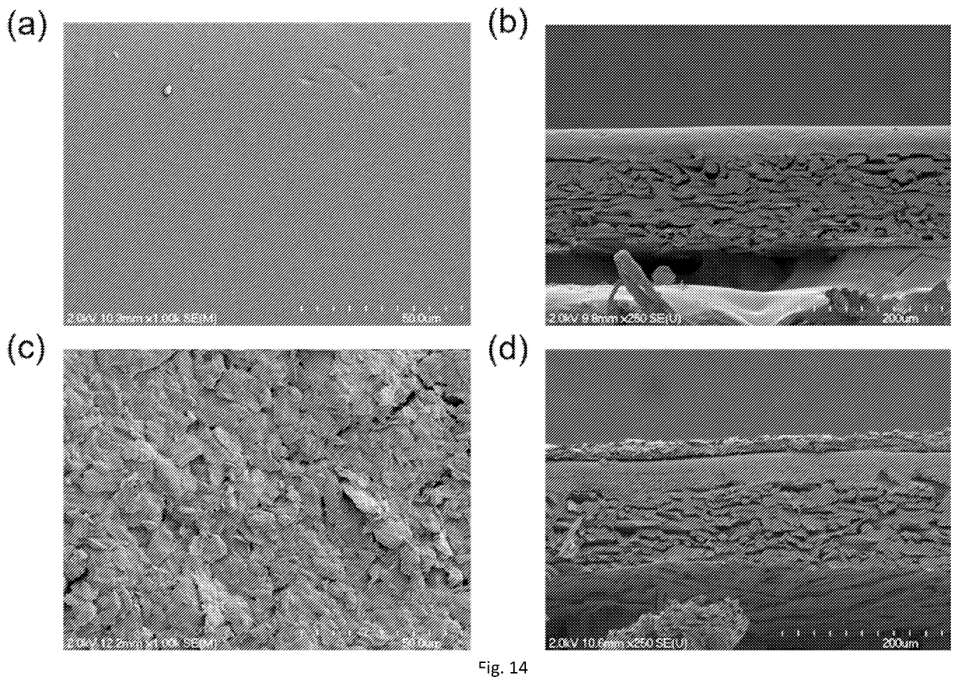

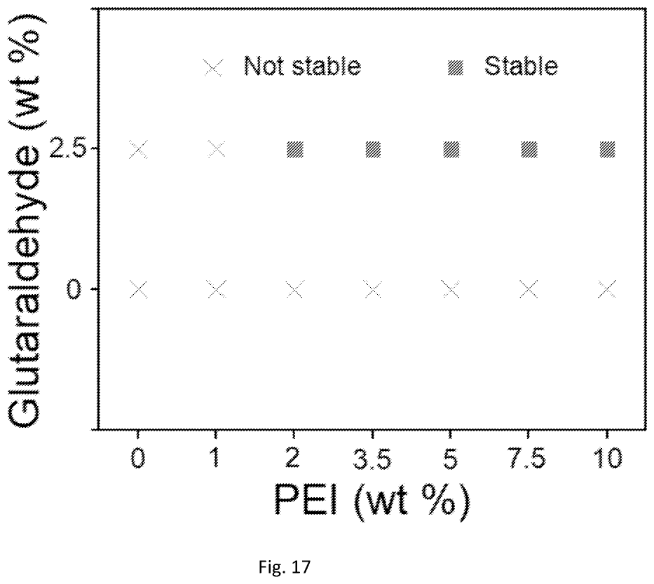

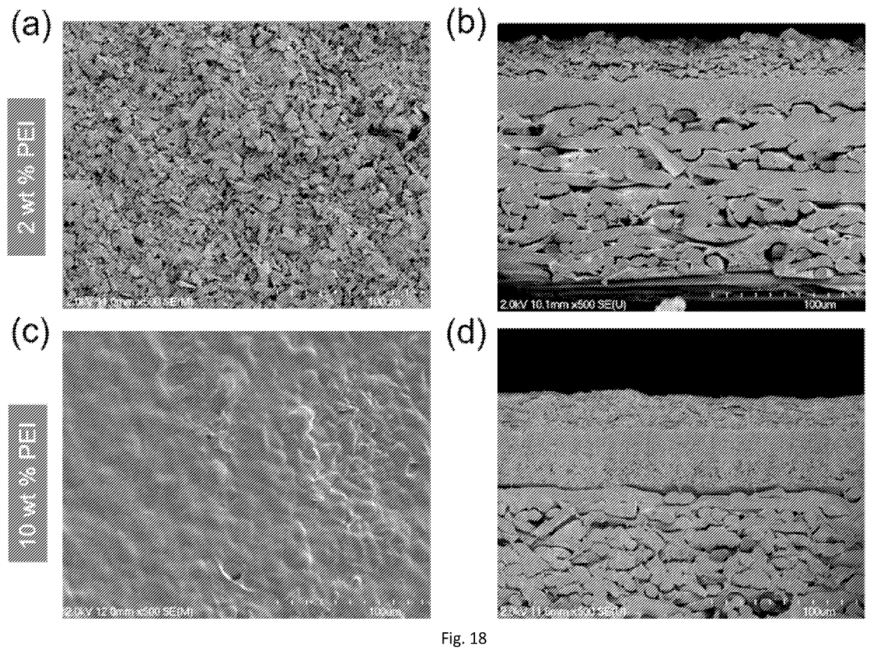

As described in FIG. 13a, the spray coated fabrication procedure for fabricating graphite-related ECMs involves spray coating of graphite mixed glutaraldehyde ethanol solution to membrane surface and subsequent PEI crosslinking in two continuous steps. Physically stable ECMs can not be obtained when using only PEI or only glutaraldehyde or a lower concentration of PEI (<2 wt %) (see FIG. 17). However, the lowest PEI concentration for the spray coated fabrication procedure (i.e., 2 wt %) is much lower than the vacuum/pressure-driven fabrication (i.e., 5 wt %) when 2.5 wt % of glutaraldehyde was used. This phenomenon should be attributed to the fact that all glutaraldehyde molecules exist on membrane surface or inside membrane pores after spray coating, while most of them were filtered out with the filtration-based protocol. Following this new approach and the combination of 2.5 wt % of glutaraldehyde with 3.5 wt % of PEI, one sheet of physically stable graphite-related ECM with an active size of ˜12 cm×18 cm was fabricated by using PSf UF commercial membrane as a base membrane in few minutes (less than 10 min) at room temperature (see FIG. 13b). One membrane coupon (˜18.09 cm²) which cut from the fabricated ECM shows high stability after 1 h water bath sonication (FIG. 13b). This membrane coupon is also stable and could be flexibly bent after overnight air-dry (FIG. 13b). The corresponding top-view and cross-section SEM images of pristine PSf membrane and fabricated ECM in FIGS. 14a-14d confirms that a graphite electroconductive layer (˜20-30 μm) coated on PSf membrane surface due to the cross-linking between PEI and glutaraldehyde. FIGS. 18a-18d further evidence that the PEI concentration (e.g., 2 or 10 wt %) affects membrane surface crosslinking but not the thickness of graphite layer. All results demonstrate that the spray deposition combined with PEI/glutaraldehyde-based cross-linking protocol is suitable for large-scale fabrication of graphite-based ECM in a short time (less than 10 min) without the assistance of vacuum/pressure-driven force.

### Example 6: Characterization of ECMs Produced Using Spray Coated Fabrication

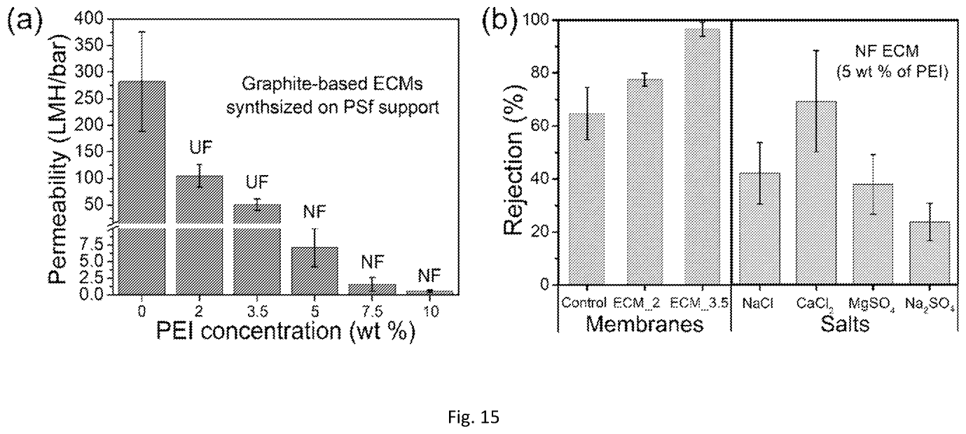

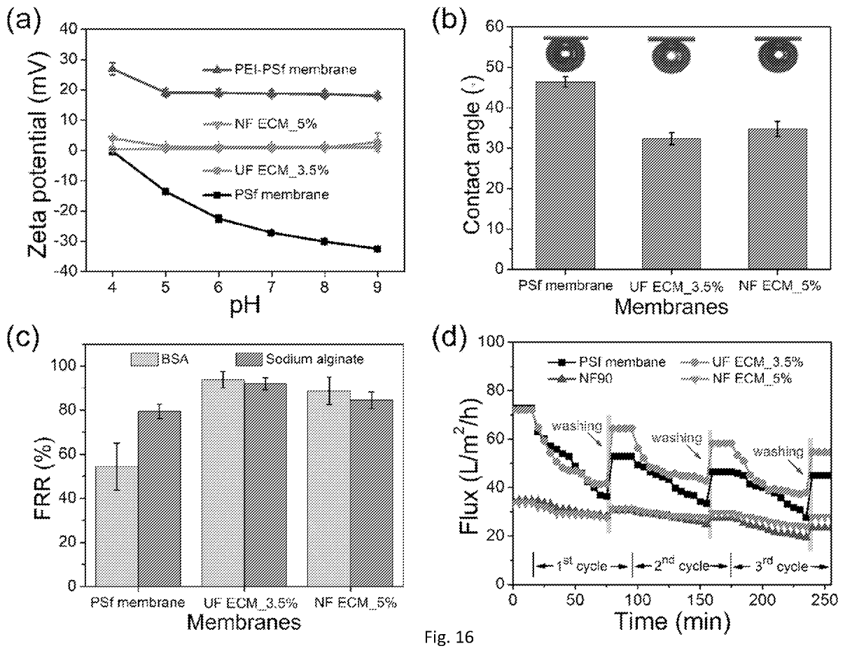

FIG. 15a presents the water permeance of synthesized ECMs when using same amount of glutaraldehyde (i.e., 2.5 wt %) but with different PEI concentrations. As seen, the membrane water permeance significantly declines from UF to NF range with the increase of PEI concentration from 2 wt % to 10 wt % due to pore blocking. Compared to PSf base membrane, the fabricated UF ECMs, when using 2 wt % or 3.5 wt % of PEI, show lower water permeance but higher BSA rejection (see the left part in FIG. 15b). The synthesized NF ECMs present a water permeability within the range of 7 to 0.5 LMH/bar when 5 wt % to 10 wt % of PEI were used. Considering the importance of water flux and separation performance for fabricated new membranes, 5 wt % of PEI was selected to fabricate NF ECM. The membrane NF behavior is confirmed by its high rejection for different salts in the right part of FIG. 15b.

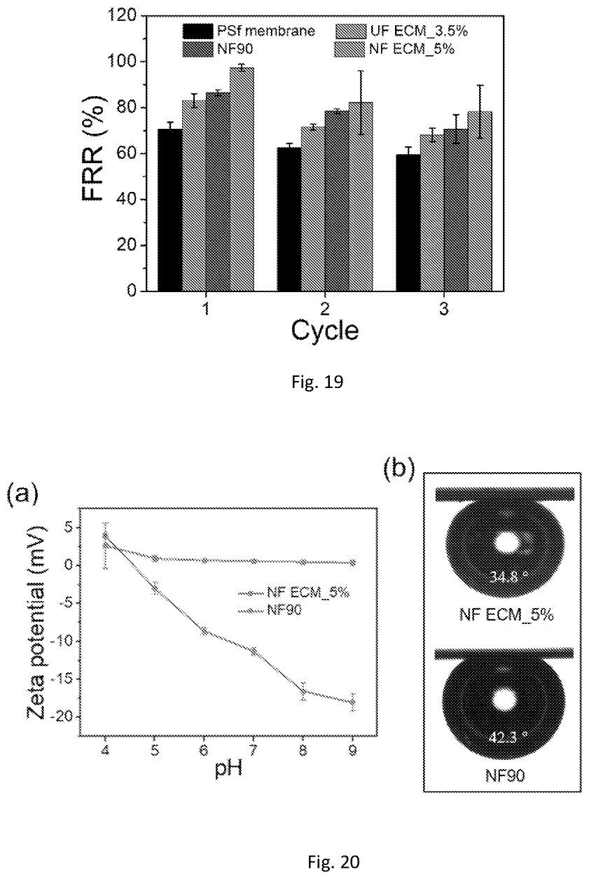

The results of zeta potential measurement in FIG. 16a show that fabricated UF and NF ECMs possess a slightly positive surface charge (or near-zero surface charge) at the solution pH range of 4-9, which is similar to vacuum/pressure-driven fabrication but different from the negatively charged PSf base membrane. When using the spray deposition approach, glutaraldehyde molecules exist on PSf base membrane surface. Due to crosslinking reaction between the positive amine group from PEI and the carbonyl group from glutaraldehyde [35, 36], the synthesized UF and NF ECMs show near-zero surface charge. This could be shown by the positive surface charge when only PEI was used to modify the PSf membrane (see FIG. 16a). Compared to the pristine PSf base membrane, the lower surface contact angle of fabricated UF and NF ECMs in FIG. 16b also display that the proposed spray coating combined with PEI-crosslinking procedure could result in more hydrophilic membranes. It is widely accepted that a membrane with near-zero surface charge and high surface hydrophilicity has less affinity to different foulants [12, 32, 51, 52]. Thus, the synthesized NF and UF ECMs described herein might possess better antifouling activity than PSf commercial membranes in water/wastewater treatment processes. To identify the antifouling performance of synthesized NF and UF ECMs, membrane flux changes before and after static adsorption for different foulants were evaluated. As seen from FIG. 16c, both synthesized UF and NF ECMs present much higher FRRs (>85%) than pristine PSf membrane (˜50-80%) in 24 h of BSA or sodium alginate static adsorption process. In addition, as displayed in FIG. 16d and FIG. 19, spray coating fabricated UF and NF ECMs also show less flux decline and higher FRRs than the pristine UF PSf or NF90 commercial membranes during the BSA filtration process at a similar initial flux, respectively. It reflects that the membrane antifouling propensity could be significantly enhanced by following spray coating fabrication for surface functionalization protocol due to the increased surface hydrophilicity and near-zero surface charge (the surface charge and water contact angle of NF90 can be found in FIGS. 20a-20b). More importantly, spray coating fabricated UF and NF ECMs displayed a low sheet resistance of 1-2 kΩ/sq (Table 2), confirming they are also electrically conductive.

TABLE 2
The sheet resistance of synthesized ECMs by
following the spray coating combined with
PEI/glutaraldehyde-based crosslinking method
(n ≥ 10).

| Base | Synthesized | Resistance |
|---|---|---|
| membrane | ECM | (kQ/sq) |
| PSf UF | UF ECM_3.5% | 1.15 ± 0.53 |
| | NF ECM_5% | 1.41 ± 0.59 |
| | NF ECM_7.5% | 1.71 ± 0.32 |
| | NF ECM_10% | 1.03 ± 0.19 |
| NF270 | NF270_2% | 1.85 ± 0.39 |
| NF90 | NF90_2% | 1.69 ± 0.62 |
| ESPA3 RO | ESPA3_2% | 1.96 ± 0.47 |
| SWC4+ RO | SWC4+_2% | 1.13 ± 0.32 |

### Example 7: Wide Practicability and Cost-Effectiveness of Spray Coating Fabricated ECMs

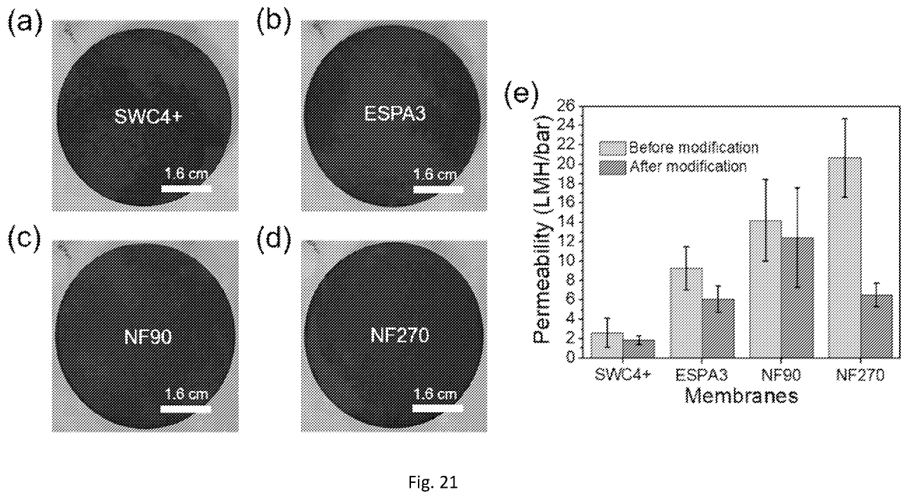

To show the broad practicability of spray deposition combined PEI-based cross-linking procedure for fabricating graphite-related ECMs, different base membranes, including SWC4+ and ESPA3 RO, NF90, and NF270 commercial membranes, were also evaluated. Following the new procedure, as seen in FIGS. 21a-21d, the physically stable ECM coupons (the active size is around 18.09 cm2) could be obtained by using those four different membranes as support in a short time (<10 min) at room temperature. After the membrane surface functionalization, all synthesized membranes show a declined water permeance (see FIG. 21e), obtained electrically conductive activity (the average resistance is 1-3 kΩ/sq, see Table 2), and also improved salts rejection (see Table 3). In addition to broad practicability, the general cost of the proposed spray coating combined PEI-based cross-linking method for fabricating one sheet of ECM, such as 1 m×1 m, was estimated. Table 4 shows that the fabrication cost mainly comprises used graphite and other chemicals (e.g., PEI, glutaraldehyde, and ethanol). According to the current retail prices of each material (Table 4), the estimated cost to prepare one sheet of ECM (e.g., 1 m×1 m) is around $5-7. This cost could go down further when this procedure is used in the industrially large-scale fabrication of ECM with mechanized operation and less-costly chemicals.

TABLE 3
The membrane (i.e., SWC4+, ESPA3, NF90, and NF270) salt rejection
changes by following the new surface functionalization strategy
(n ≥ 2).

| | | The rejection (%) for different salts | | | |
|---|---|---|---|---|---|
| Membranes | | NaCl | CaCl₂ | Na₂SO₄ | MgSO₄ |
| SWC4+ | Before | 87.16 ± 6.22 | 81.08 ± 1.35 | 88.38 ± 7.68 | 78.25 ± 0.81 |
| | After | 91.86 ± 3.05 | 88.59 ± 5.08 | 85.44 ± 1.92 | 86.68 ± 4.91 |
| ESPA3 | Before | 68.18 ± 5.42 | 52.05 ± 12.18 | 75.91 ± 8.67 | 62.87 ± 0.38 |
| | After | 79.72 ± 5.98 | 84.41 ± 0.45 | 82.34 ± 4.35 | 82.79 ± 4.67 |
| NF90 | Before | 63.27 ± 8.31 | 59.88 ± 8.14 | 75.57 ± 2.13 | 62.99 ± 6.62 |
| | After | 70.52 ± 5.46 | 80.36 ± 1.89 | 77.91 ± 0.53 | 70.61 ± 4.47 |
| NF270 | Before | 21.84 ± 2.89 | 35.29 ± 5.33 | 68.18 ± 5.42 | 64.09 ± 7.52 |
| | After | 33.46 ± 5.79 | 53.21 ± 8.09 | 72.53 ± 1.69 | 68.94 ± 6.54 |

TABLE 4
Retail price of the materials and chemicals from commercial suppliers
and the required amount (or cost) to prepare ECM with a size of 1 m².

| | | | | Required amount |
|---|---|---|---|---|
| | | | | (or usage time) for |
| | | | | the preparation |
| | Materials/ | | | of ECM with a |
| No. | Chemicals | Supplier | Cost for order | size of 1 m² |
| 1 | Graphite | Sigma | $78.6 (1 kg) | Stock solution A |
| 2 | Glutaraldehyde | Sigma | $26.78 | (100 mL) |
| | (25 wt %) | | (100 mL) | |
| 3 | Ethanol | Fisher | $76.68 (20 L) | |
| 4 | Polyethyleneimine | Sigma | $83.6 (100 g) | Stock solution B |
| | | | | (40 mL) |
| 5 | Electric paint | Amazon | $39.19 | The estimated |
| | sprayer | | | minimum |
| | | | | usage time is |
| | | | | 1000 times |
| 6 | Double size tape | Amazon | $2.75 | One-third of total |
| | | | (~1.3 cm × 11 m) | |

The cost of preparing 100 mL stock solution A (i.e., 100 mg/ml of graphite containing 2.5 wt % of glutaraldehyde in ethanol) is around $3.85 (i.e., $0.786+$2.678+$0.3834).

The cost for preparation of 40 mL stock solution B (i.e., 2-5 wt % of PEI in ethanol) is around $0.82-1.82 (i.e., $0.67-1.67+$0.15).

Other costs (e.g., sprayer and tape) are around $1 (i.e., $0.04+$0.9).

Therefore, the final estimated cost (not including base membrane) for fabricating ECM with a size of 1 m2 (e.g., 1 m×1 m) is $5.67-6.67 when done at a small lab-bench scale.

Spray deposition combined with a PEI/glutaraldehyde-based crosslinking procedure could be utilized for large-scale production of different graphite-related ECMs in a short time (less than 10 min) at room temperature. Compared to PSf base membrane, these spray coating fabricated graphite-related ECMs displayed not only controllable water permeance by changing PEI concentration but also own near-zero surface charge, higher surface hydrophilicity, less BSA adsorption (the FRR is more than 90% after 24 h adsorption), and much lower sheet resistance (˜1-2 kΩ/sq). In addition, the proposed method for fabrication of ECMs described herein is fit for different commercial membranes and is also evidenced as a low-cost consumption procedure (i.e., $5-7 for 1 m2). Overall, spray deposition combined with PEI/glutaraldehyde-based crosslinking protocol is suitable for practical large-scale fabrication of RO, NF, and UF ECMs, which might be potentially employed in commercial applications.

Many modifications and other embodiments of the inventions set forth herein will come to mind to one skilled in the art to which the inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

### REFERENCES

[1] R. Zhang, Y. Liu, M. He, Y. Su, X. Zhao, M. Elimelech, Z. Jiang, Antifouling membranes for sustainable water purification: strategies and mechanisms, Chemical Society Reviews 45 (21) (2016) 5888-5924.
[2] M. A. Shannon, P. W. Bohn, M. Elimelech, J. G. Georgiadis, B. J. Marinas, A. M. Mayes, Science and technology for water purification in the coming decades, Nature (2010) 337-346.
[3] M. Elimelech, W. Phillip, The future of seawater desalination: energy, technology, and the environment, Science 333 (6043) (2011) 712-717.
[4] E. Obotey Ezugbe, S. Rathilal, Membrane technologies in wastewater treatment: a review, Membranes 10 (5) (2020) 89.
[5] A. Subramani, J. Jacangelo, Emerging desalination technologies for water treatment: a critical review, Water Research 75 (2015) 164-187.
[6] Y.-X. Xie, K.-K. Wang, W.-H. Yu, M.-B. Cui, Y.-J. Shen, X.-Y. Wang, L.-F. Fang, B.-K. Zhu, Improved permeability and antifouling properties of polyvinyl chloride ultrafiltration membrane via blending sulfonated polysulfone, Journal of Colloid and Interface Science 579 (2020) 562-572.
[7] W. Zhang, Y. Yang, E. Ziemann, A. Be'er, M. Y. Bashouti, M. Elimelech, R. Bernstein, One-step sonochemical synthesis of a reduced graphene oxide-ZnO nanocomposite with antibacterial and antibiofouling properties, Environmental Science: Nano 6 (10) (2019) 3080-3090.
[8] X. Zhao, R. Zhang, Y. Liu, M. He, Y. Su, C. Gao, Z. Jiang, Antifouling membrane surface construction: Chemistry plays a critical role, Journal of Membrane Science 551 (2018) 145-171.
[9] W. Cheng, X. Lu, M. Kaneda, W. Zhang, R. Bernstein, J. Ma, M. Elimelech, Graphene oxide-functionalized membranes: the importance of nanosheet surface exposure for biofouling resistance, Environmental Science & Technology 54 (1) (2019) 517-526.
[10] L. Deng, S. Li, Y. Qin, L. Zhang, H. Chen, Z. Chang, Y. Hu, Fabrication of antifouling thin-film composite nanofiltration membrane via surface grafting of polyethyleneimine followed by zwitterionic modification, Journal of Membrane Science 619 (2021) 118564.
[11] X. Chen, E. Deng, D. Park, B. A. Pfeifer, N. Dai, H. Lin, Grafting activated graphene oxide nanosheets onto ultrafiltration membranes using polydopamine to enhance antifouling properties, ACS Applied Materials Interfaces 12 (42) (2020) 48179-48187.
[12] W. Zhang, Z. Yang, Y. Kaufman, R. Bernstein, Surface and anti-fouling properties of a polyampholyte hydrogel grafted onto a polyethersulfone membrane, Journal of Colloid and Interface Science 517 (2018) 155-165.
[13] F. Ahmed, B. S. Lalia, V. Kochkodan, N. Hilal, R. Hashaikeh, Electrically conductive polymeric membranes for fouling prevention and detection: A review, Desalination 391 (2016) 1-15.
[14] W. Yu, Y. Liu, Y. Xu, R. Li, J. Chen, B.-Q. Liao, L. Shen, H. Lin, A conductive PVDF-Ni membrane with superior rejection, permeance and antifouling ability via electric assisted in-situ aeration for dye separation, Journal of Membrane Science 581 (2019) 401-412.
[15] R. Li, Y. Wu, L. Shen, J. Chen, H. Lin, A novel strategy to develop antifouling and antibacterial conductive Cu/polydopamine/polyvinylidene fluoride membranes for water treatment, Journal of Colloid and Interface Science 531 (2018) 493-501.
[16] S. Ma, F. Yang, X. Chen, C. M. Khor, B. Jung, A. Iddya, G. Sant, D. Jassby, Removal of As (III) by Electrically Conducting Ultrafiltration Membranes, Water Research 204 (2021) 117592.
[17] A. V. Dudchenko, J. Rolf, K. Russell, W. Duan, D. Jassby, Organic fouling inhibition on electrically conducting carbon nanotube-polyvinyl alcohol composite ultrafiltration membranes, Journal of Membrane Science 468 (2014) 1-10.
[18] S. F. Anis, B. S. Lalia, M. Khair, R. Hashaikeh, N. Hilal, Electro-ceramic self-cleaning membranes for biofouling control and prevention in water treatment, Chemical Engineering Journal 415 (2021) 128395.
[19] C. Thamaraiselvan, A. K. Thakur, A. Gupta, C. Arnusch, Electrochemical Removal of Organic and Inorganic Pollutants Using Robust Laser-Induced Graphene Membranes, ACS Applied Materials Interfaces 13 (1) (2021) 1452-1462.
[20] C. Thamaraiselvan, D. Bandyopadhyay, C. D. Powell, C. Arnusch, Electrochemical degradation of emerging pollutants via laser-induced graphene electrodes, Chemical Engineering Journal Advances 8 (2021) 100195.
[21] A. K. Thakur, S. P. Singh, M. c. N. Kleinberg, A. Gupta, C. J. Arnusch, Laser-induced graphene-PVA composites as robust electrically conductive water treatment membranes, ACS Applied Materials Interfaces 11 (11) (2019) 10914-10921.
[22] K. Ho, Y. Teow, A. Mohammad, W. Ang, P. Lee, Development of graphene oxide (GO)/multi-walled carbon nanotubes (MWCNTs) nanocomposite conductive membranes for electrically enhanced fouling mitigation, Journal of Membrane Science 552 (2018) 189-201.
[23] A. P. Straub, D. S. Bergsman, B. A. Getachew, L. M. Leahy, J. J. Patil, N. Ferralis, J. C. Grossman, Highly Conductive and Permeable Nanocomposite Ultrafiltration Membranes Using Laser-Reduced Graphene Oxide, Nano Letters 21 (6) (2021) 2429-2435.
[24] M. A. Halali, C.-F. o. de Lannoy, Quantifying the Impact of Electrically Conductive Membrane-Generated Hydrogen Peroxide and Extreme pH on the Viability of Escherichia coli Biofilms, Industrial Engineering Chemistry Research (2021).
[25] A. Ronen, W. Duan, I. Wheeldon, S. Walker, D. Jassby, Microbial attachment inhibition through low-voltage electrochemical reactions on electrically conducting membranes, Environmental Science & Technology 49 (21) (2015) 12741-12750.
[26] C. De Lannoy, D. Jassby, D. Davis, M. Wiesner, A highly electrically conductive polymer-multiwalled carbon nanotube nanocomposite membrane, Journal of Membrane Science 415 (2012) 718-724.
[27] M. A. Halali, C.-F. de Lannoy, Methods for stability assessment of electrically conductive membranes, MethodsX (2022) 101627.
[28] X. Xu, H. Zhang, M. Yu, Y. Wang, T. Gao, F. Yang, Conductive thin film nanocomposite forward osmosis membrane (TFN-FO) blended with carbon nanoparticles for membrane fouling control, Science of The Total Environment 697 (2019) 134050.
[29] C.-F. de Lannoy, D. Jassby, K. Gloe, A. D. Gordon, M. R. Wiesner, Aquatic biofouling prevention by electrically charged nanocomposite polymer thin film membranes, Environmental Science & Technology 47 (6) (2013) 2760-2768.
[30] M. Stolov, V. Freger, Degradation of polyamide membranes exposed to chlorine: an impedance spectroscopy study, Environmental Science & Technology 53 (5) (2019) 2618-2625.
[31] A. S. H. Makhlouf, M. Aliofkhazraei, Handbook of materials failure analysis with case studies from the aerospace and automotive industries, Butterworth-Heinemann2015.
[32] W. Zhang, H. Huang, R. Bernstein, Zwitterionic hydrogel modified reduced graphene oxide/ZnO nanocomposite blended membrane with high antifouling and antibiofouling performances, Journal of Colloid and Interface Science 613 (2022) 426-434.
[33] S. Seiler, C. E. Halbig, F. Grote, P. Rietsch, F. Börrnert, U. Kaiser, B. Meyer, S. Eigler, Effect of friction on oxidative graphite intercalation and high-quality graphene formation, Nature Communications 9 (1) (2018) 1-9.
[34] J. Li, S. Yuan, J. Zhu, B. Van der Bruggen, High-flux, antibacterial composite membranes via polydopamine-assisted PEI-TiO2/Ag modification for dye removal, Chemical Engineering Journal 373 (2019) 275-284.
[35] W. Gutowski, A. Bilyk, S. Li, M. Espiritu, I. Burgar, The influence of structure of the interface and interphase on paint adhesion, Composite Interfaces 12 (8-9) (2005) 817-835.
[36] J. Wang, C. Li, F. Wang, B. Yu, Y. Luo, H. Zeng, H. Zhu, Hydrophilic modification of PTFE microfiltration flat membrane by crosslinking OCMCS-PEI to enhance anti-fouling property, Progress in Organic Coatings 135 (2019) 565-573.
[37] M. Kaganovich, W. Zhang, V. Freger, R. Bernstein, Effect of the membrane exclusion mechanism on phosphate scaling during synthetic effluent desalination, Water Research 161 (2019) 381-391.
[38] J. Zheng, X. Zhang, G. Li, G. Fei, P. Jin, Y. Liu, C. Wouters, G. Meir, Y. Li, B. Van der Bruggen, Selective removal of heavy metals from saline water by nanofiltration, Desalination 525 (2022) 115380.
[39] M. Panizza, A. Barbucci, R. Ricotti, G. Cerisola, Electrochemical degradation of methylene blue, Separation Purification Technology 54 (3) (2007) 382-387.
[40] F. Perreault, A. F. De Faria, S. Nejati, M. Elimelech, Antimicrobial properties of graphene oxide nanosheets: why size matters, ACS nano 9 (7) (2015) 7226-7236.
[41] M. S. Rahaman, H. Thérien-Aubin, M. Ben-Sasson, C. K. Ober, M. Nielsen, M. Elimelech, Control of biofouling on reverse osmosis polyamide membranes modified with biocidal nanoparticles and antifouling polymer brushes, Journal of Materials Chemistry B 2 (12) (2014) 1724-1732.
[42] J. Liu, C. Tian, J. Xiong, B. Gao, S. Dong, L. Wang, Polypyrrole vapor phase polymerization on PVDF membrane surface for conductive membrane preparation and fouling mitigation, Journal of Chemical Technology Biotechnology 93 (3) (2018) 683-689.
[43] Y. Yuan, C. Tian, J. Liu, PEDOT surface modified PVDF filtration membrane for conductive membrane preparation and fouling mitigation, Journal of Environmental Chemical Engineering 9 (3) (2021) 105212.
[44] T.-K. Hong, D. W. Lee, H. J. Choi, H. S. Shin, B.-S. Kim, Transparent, flexible conducting hybrid multilayer thin films of multiwalled carbon nanotubes with graphene nanosheets, ACS Nano 4 (7) (2010) 3861-3868.
[45] B. Stevens, E. Dessiatova, D. A. Hagen, A. D. Todd, C. W. Bielawski, J. C. Grunlan, Interfaces, Low-temperature thermal reduction of graphene oxide nanobrick walls: Unique combination of high gas barrier and low resistivity in fully organic polyelectrolyte multilayer thin films, ACS Applied Materials Interfaces 6 (13) (2014) 9942-9945.
[46] J. Zhao, S. Pei, W. Ren, L. Gao, H.-M. Cheng, Efficient preparation of large-area graphene oxide sheets for transparent conductive films, ACS Nano 4 (9) (2010) 5245-5252.
[47] A. P. Straub, D. S. Bergsman, B. A. Getachew, L. M. Leahy, J. J. Patil, N. Ferralis, J. C. Grossman, Highly Conductive and Permeable Nanocomposite Ultrafiltration Membranes Using Laser-Reduced Graphene Oxide. Nano Letters 21 (6) (2021) 2429-2435.
[48] C. Thamaraiselvan, A. K. Thakur, A. Gupta, C. Arnusch, Electrochemical Removal of Organic and Inorganic Pollutants Using Robust Laser-Induced Graphene Membranes. ACS Applied Materials Interfaces 13 (1) (2021) 1452-1462.
[49] R. Kingsbury, K. Bruning, S. Zhu, S. Flotron, C. Miller, O. Coronell, Influence of water uptake, charge, manning parameter, and contact angle on water and salt transport in commercial ion exchange membranes, Industrial & Engineering Chemistry Research, 58 (2019) 18663-18674.
[50] A. J. Atkinson, J. Wang, Z. Zhang, A. Gold, D. Jung, D. Zeng, A. Pollard, O. Coronell, Grafting of bioactive 2-aminoimidazole into active layer makes commercial RO/NF membranes anti-biofouling, Journal of Membrane Science, 556 (2018) 85-97.
[51] M. He, K. Gao, L. Zhou, Z. Jiao, M. Wu, J. Cao, X. You, Z. Cai, Y. Su, Z. Jiang, Zwitterionic materials for antifouling membrane surface construction, Acta Biomaterialia, 40 (2016) 142-152.
[52] D. Rana, T. Matsuura, Surface modifications for antifouling membranes, Chemical reviews, 110 (2010) 2448-2471.

What is claimed is:

1. An electrically conductive filtration membrane comprising:
a porous or nonporous matrix; and
an electrically conductive layer disposed on the porous or nonporous matrix, the electrically conductive layer comprising surface-modified electrically conductive material disposed on the porous or nonporous matrix and an amine-containing polymer crosslinked to the surface-modified electrically conductive material.

2. The membrane of claim 1, wherein the electrically conductive layer is disposed on one side of the porous or nonporous matrix.

3. The membrane of claim 1 or 2, wherein the conductive material is selected from the group consisting of graphite, carbon nanotubes, activated charcoal, reduced graphene oxides, and silver nanoparticles, and combinations thereof.

4. The membrane of claim 3, wherein the conductive material is graphite.

5. The membrane of any one of claims 1-4, wherein the amine-containing polymer comprises one or more primary, secondary, and tertiary amines.

6. The membrane of claim 5, wherein the amine-containing polymer is linear or branched.

7. The membrane of claim 6, wherein the amine-containing polymer is a branched amine-containing polymer.

8. The membrane of claim 7, wherein the amine-containing polymer is a branched polyethylenimine (PEI) polymer.

9. The membrane of any one of claims 1-8, wherein the crosslinked polymer is crosslinked with a crosslinking agent selected from the group consisting of aldehydes, dialdehydes, diacrylates, and epoxides.

10. The membrane of claim 9, wherein the crosslinking agent is a dialdehyde.

11. The membrane of claim 10, wherein the crosslinking agent is glutaraldehyde.

12. The membrane of any one of claims 1-11, wherein the crosslinked amine-containing polymer is present in an amount from about 2 wt % to about 20 wt % of the amine-containing polymer solution.

13. The membrane of claim 12, wherein the crosslinked amine-containing polymer is present in an amount from about 5 wt % to about 15 wt % of the amine-containing polymer solution.

14. The membrane of claim 13, wherein the crosslinked amine-containing polymer is present in an amount of about 10 wt % of the amine-containing polymer solution.

15. The membrane of claim 13, wherein the crosslinked amine-containing polymer is present in an amount of about 5 wt % of the amine-containing polymer solution.

16. The membrane of any one of claims 1-15, wherein the crosslinking agent is present in an amount from about 1 wt % to about 10 wt % of the crosslinking solution, wherein the crosslinking solution comprises the crosslinking agent and the conductive material.

17. The membrane of claim 16, wherein the crosslinking agent is present in an amount from about 1 wt % to about 5 wt % of the crosslinking solution.

18. The membrane of claim 17, wherein the crosslinking agent is present in an amount of about 2.5 wt % of the crosslinking solution.

19. The membrane of any one of claims 1-18, wherein the porous or non-porous matrix is a non-conductive pristine membrane selected from the group consisting of a reverse osmosis membrane, an ultrafiltration membrane, a nanofiltration membrane, and a microfiltration membrane.

20. The membrane of claim 19, wherein the porous or nonporous matrix is selected from the group consisting of SWC 4+, ESPA 3, NF270, PSf 20 KDa and PVDF membranes.

21. The membrane of claim 20, wherein the porous or nonporous matrix is a PVDF membrane.

22. The membrane of claim 21, wherein the PVDF membrane has a pore size from about 0.1 μm to about 0.8 μm.

23. The membrane of claim 22, wherein the PVDF membrane has a pore size of about 0.1 μm.

24. The membrane of claim 20, wherein the porous or nonporous matrix is a PSf 20 KDa membrane.

25. The membrane of any one of claims 1-24, wherein the membrane has increased antifouling compared to the porous or nonporous matrix without the electrically conductive layer.

26. The membrane of claim 1, wherein:
the porous or nonporous matrix is reverse osmosis membrane;
the electrically conductive material is graphite; and
the amine-containing polymer is PEI,
wherein the PEI is crosslinked to the graphite through a residue of glutaraldehyde.

27. The membrane of claim 26, wherein:
the PEI is present in an amount of about 10 wt % of the amine-containing polymer solution; and,
the crosslinking agent is present in an amount of about 2.5 wt % of the solution containing the crosslinking agent and conductive material.

28. The membrane of claim 1, wherein:
the porous or nonporous matrix is an ultrafiltration or a nanofiltration membrane;
the electrically conductive material is graphite; and
the amine-containing polymer is PEI,
wherein the PEI is crosslinked to the graphite through a residue of glutaraldehyde.

29. The membrane of claim 28, wherein:
the PEI is present in an amount of about 5 wt % of the amine-containing polymer solution; and,
the crosslinking agent is present in an amount of about 2.5 wt % of the solution containing the crosslinking agent and conductive material.

30. A method of preparing the electrically conductive filtration membrane of any one of claims 1-29, comprising:
contacting a porous or nonporous matrix with a first solution of an electrically conductive crosslinking solution comprising a surface-modified electrically conductive material bound to a crosslinking agent,
wherein the surface-modified electrically conductive material is deposited on the surface of the porous or nonporous matrix to form a first membrane; and
contacting the first membrane with a second solution of an amine-containing polymer,
wherein the polymer is crosslinked to the surface-modified electrically conductive material to form the electrically conductive layer disposed on the porous matrix.

31. The method of claim 30, wherein the surface-modified electrically conductive material is deposited via vacuum filtration or pressure-driven filtration.

32. The method of claim 30, wherein the surface-modified electrically conductive material is deposited via spray deposition.

33. The method of any one of claims 30-32, wherein the electrically conductive layer is disposed on one side of the porous or nonporous matrix.

34. A method of modifying the pore size of a porous matrix layer, comprising:
contacting the porous matrix and surface-modified electrically conductive material with an amine-containing polymer, wherein the polymer is crosslinked to the surface-modified electrically conductive material on the surface of the porous matrix, and optionally directly within the pores of the porous matrix;
wherein the pore size of the porous matrix decreases in size.

35. A method of preventing or reducing fouling of a non-conductive pristine membrane, comprising:
contacting a non-conductive pristine membrane with a first solution of an electrically conductive crosslinking solution comprising a surface-modified electrically conductive material bound to a crosslinking agent,
wherein the surface-modified electrically conductive material is deposited on the surface of the non-conductive pristine membrane to form a first membrane; and contacting the first membrane with a second solution of an amine-containing polymer,
wherein the polymer is crosslinked to the surface-modified electrically conductive material to form an electrically conductive layer disposed on the non-conductive pristine membrane;
wherein an electrically conductive filtration membrane is prepared.

36. A method of purifying a liquid feed stream, comprising:
allowing the liquid feed stream to filter through an electrically conductive filtration membrane comprising:
a porous or nonporous matrix; and
an electrically conductive layer disposed on one side of the porous matrix, the electrically conductive layer comprising surface-modified electrically conductive material disposed on the porous or nonporous matrix and an amine-containing polymer crosslinked to the surface-modified electrically conductive material;
wherein a purified liquid is produced.
